(19) United States
(12) Patent Application Publication
(10) Pub. No.: US 2017/0228022 A1
(43) Pub. Date: Aug. 10, 2017

(54) ELECTRONIC DEVICE AND METHOD FOR CONTROLLING ELECTRONIC DEVICE

(71) Applicant: FUJITSU LIMITED, Kawasaki-shi (JP)

(72) Inventor: Takeaki SHIMANOUCHI, Akashi (JP)

(73) Assignee: FUJITSU LIMITED, Kawasaki-shi (JP)

(21) Appl. No.: 15/498,097

(22) Filed: Apr. 26, 2017

Related U.S. Application Data
(63) Continuation of application No. PCT/JP2014/079960, filed on Nov. 12, 2014.

(51) Int. Cl. G06F 3/01; G06F 3/041

(52) U.S. Cl. CPC G06F 3/016; G06F 3/0416

(57) ABSTRACT

An electronic device includes: a top panel having a manipulation input surface; a coordinate detector configured to detect coordinates of a manipulation input performed on the manipulation input surface; a housing; a first vibrating element disposed on the top panel; at least one support configured to support the top panel with respect to the housing, support stiffness of the at least one support with respect to the housing being switchable between a first level and a second level; and a controlling part configured to set the support stiffness to the first level when driving the first vibrating element by using a first driving signal for generating a natural vibration in an ultra sound frequency band and to set the support stiffness to the second level when driving the first vibrating element by using a second driving signal for generating a vibration in an audible range.

### CROSS-REFERENCE TO RELATED APPLICATION

This application is a continuation application of International Application PCT/JP2014/079960 filed on Nov. 12, 2014 and designated the U.S., the entire contents of which are incorporated herein by reference.

### FIELD

The embodiments discussed herein relate to an electronic device and a method for controlling an electronic device.

### BACKGROUND

Conventionally, there exists a data input device that includes a touch input interface having a touch sensing mechanism, and a plurality of regions of material that is arranged to change its shape, size or rheology using application of an applied voltage. The data input device applies a voltage to a region where the shape, size, or rheology of material is changed in the region where a user's touch is detected by the touch sensing mechanism so that the region touched by the user is activated at least temporarily to provide a tactile indication of the region touched by the user. The material is an electroactive polymer (EAP), a smart fluid such as an electrorheological fluid or a piezoelectric material (for example, see Patent Document 1).

However, as the plurality of regions of the conventional data input device is realized by a smart fluid as described above, the conventional data input device has an upper limit for the operable frequency and cannot be driven in an ultrasound frequency band, for example. Thus, tactile sensations that can be provided are limited.

### RELATED-ART DOCUMENTS

### Patent Documents

[Patent Document 1] National Publication of International Patent Application No. 2012-521027

### SUMMARY

According to an aspect of the embodiments, an electronic device includes: a top panel having a manipulation input surface on a surface side of the top panel; a coordinate detector configured to detect coordinates of a manipulation input performed on the manipulation input surface; a housing disposed on a back surface side of the top panel; a first vibrating element disposed on the top panel; at least one support configured to support the top panel with respect to the housing, support stiffness of the at least one support with respect to the housing being switchable between a first level and a second level that is less than the first level; and a controlling part configured to set the support stiffness of the at least one support to the first level when driving the first vibrating element by using a first driving signal for generating a natural vibration in an ultrasound frequency band in the manipulation input surface and to set the support stiffness of the at least one support to the second level when driving the first vibrating element by using a second driving signal for generating a vibration in an audible range in the manipulation input surface.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a perspective view illustrating an electronic device 100 according to a first embodiment;

FIG. 2 is a plan view illustrating the electronic device 100 according to the first embodiment;

FIG. 3A is s cross-sectional view of the electronic device 100 taken along a line A-A of FIG. 2;

FIG. 3B is a cross-sectional view of the electronic device 100 taken along a line B-B of FIG. 2;

FIG. 4 is a diagram illustrating a simulation model;

FIGS. 5A to 5D are diagrams illustrating simulation results;

FIG. 6 is a diagram illustrating a structure of a support 130;

FIGS. 7A and 7B are diagrams illustrating cases where a kinetic friction force applied to a user's fingertip performing a manipulation input is varied by a natural vibration in an ultrasound frequency band generated in a top panel 120 of the electronic device 100;

FIG. 8 is a diagram illustrating a configuration of the electronic device 100 according to the first embodiment;

FIGS. 9A and 9B are diagrams illustrating control data stored in a memory 250;

FIG. 10 is a flowchart illustrating processing that is executed by a drive controlling part 240 of a drive controlling apparatus 300 of the electronic device 100 according to the first embodiment;

FIG. 11 is a flowchart illustrating processing that is executed by the drive controlling part 240 of the drive controlling apparatus 300 of the electronic device 100 according to the first embodiment;

FIG. 12 is a diagram illustrating an operating example of the electronic device 100 according to the first embodiment;

FIG. 13 is a diagram illustrating the operating example of the electronic device 100 according to the first embodiment;

FIG. 14 is a diagram illustrating an operating example of the electronic device 100 according to the first embodiment;

FIGS. 15A to 15C are diagrams illustrating a control pattern of the supports 130 for providing a stroke feeling, and a reaction force that expresses the stroke feeling;

FIG. 16A is a diagram illustrating a part of an electronic device 100V1 according to a variation example of the first embodiment;

FIG. 16B is a diagram illustrating a part of an electronic device 100V2 according to a variation example of the first embodiment;

FIG. 17 is a cross sectional view illustrating a structure of a support 530 according to a second embodiment;

FIG. 18A is a diagram illustrating a result of measuring an amount of deformation (amount of push) of the support 530 being compressed in the Z axis direction with respect to an external force Fz applied to the support 530 in the Z axis direction;

FIG. 18B is a diagram illustrating a result of measuring an amount of deformation (amount of push) of the support 530 being compressed in the Z axis direction with respect to an external force Fs, applied to the support 530 in a shearing direction;

FIG. 19A is a cross sectional view illustrating a support 530A; and

FIG. 19B is a cross sectional view illustrating a support 530B.

### DESCRIPTION OF EMBODIMENTS

Hereinafter, embodiments to which an electronic device of the present invention is applied will be described. An object in one aspect of the embodiments is to provide an electronic device that can provide various favorable tactile sensations.

### First Embodiment

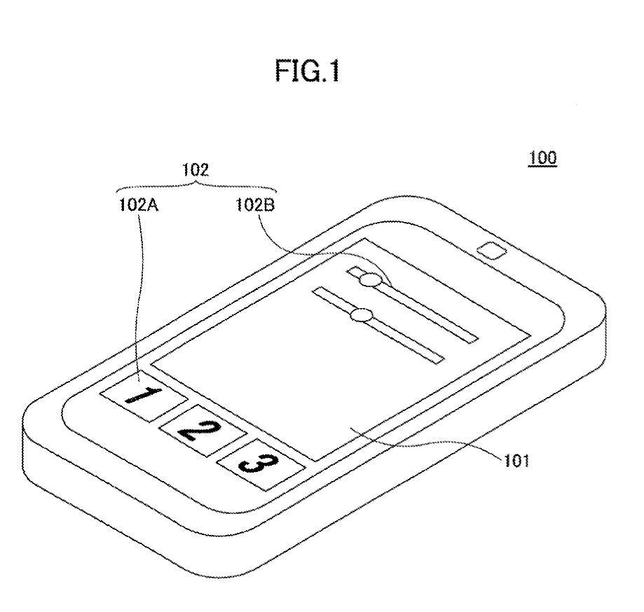

FIG. 1 is a perspective view illustrating an electronic device 100 according to a first embodiment.

For example, the electronic device 100 is a smartphone terminal device or a tablet computer that has a touch panel as a manipulation input part. The electronic device 100 may be any device as long as the device has a touch panel as a manipulation input part. Accordingly, the electronic device 100 may be a device such as a portable-type information terminal device, or an Automatic Teller Machine (ATM) placed at a specific location to be used, for example.

In a manipulation input part 101 of the electronic device 100, a display panel is disposed under a touch panel, and various buttons including a button 102A, a slider 102B and the like (hereinafter referred to as Graphic User Interface (GUI) manipulation part(s) 102) are displayed on the display panel.

A user of the electronic device 100 ordinarily touches the manipulation input part 101 by a fingertip in order to manipulate the GUI manipulation part 102.

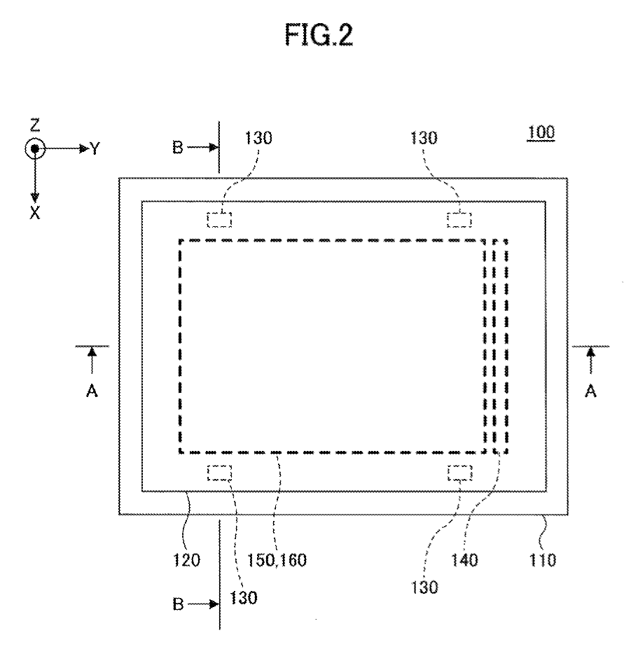

Hereinafter, a detailed configuration of the electronic device 100 will be described with reference to FIG. 2.

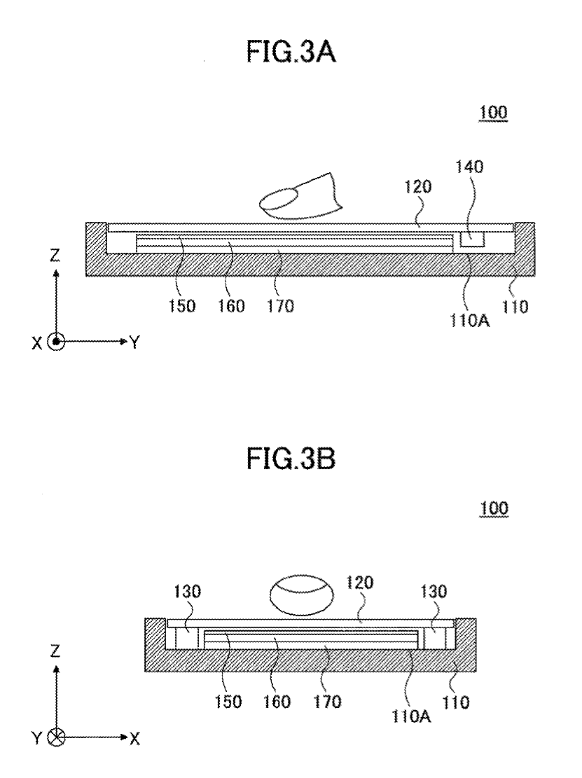

FIG. 2 is a plan view illustrating the electronic device 100 of the first embodiment. FIGS. 3A and 3B are cross-sectional views of the electronic device 100 illustrated in FIG. 2. FIG. 3A illustrates a cross-sectional view taken along a line A-A of FIG. 2. FIG. 3B illustrates a cross-sectional view taken along a line B-B of FIG. 2. It should be noted that a XYZ coordinate system that is an orthogonal coordinate system is defined as illustrated in FIGS. 2 and 3.

The electronic device 100 includes a housing 110, a top panel 120, supports 130, a vibrating element 140, a touch panel 150, a display panel 160, and a substrate 170.

The housing 110 is made of a plastic, for example. As illustrated in FIGS. 3A and 3B, the substrate 170, the display panel 160, and the touch panel 150 are disposed in a recessed portion 110A, and the top panel 120 is fixed to the housing 110 by the supports 130.

The top panel 120 is a thin flat-plate member having a rectangular shape in plan view, and is made of transparent glass or a reinforced plastic such as polycarbonate. A surface of the top panel 120 (a positive side surface in the Z axis direction) is one example of a manipulation input surface on which the user of the electronic device 100 performs a manipulation input.

The supports 130 and the vibrating element 140 are bonded on a negative side surface of the top panel 120 in the Z axis direction. The top panel 120 is fixed to the housing 110 by the supports 130. It should be noted that the four sides in plan view of the top panel 120 may be bonded to the housing 110 by a double-faced adhesive tape or the like. Further, a waterproof film, a dust-proof film, or the like may be prepared on a clearance gap between the top panel 120 and the housing 110.

The touch panel 150 is disposed on the negative side in the Z axis direction of the top panel 120. The top panel 120 is provided in order to protect the surface of the touch panel 150. It should be noted that another panel, a protective film or the like may be further provided on the surface of the top panel 120. The touch panel 150 may be disposed on a positive side of the top panel 120 in the Z axis direction. The touch panel 150 may be attached to the negative side of the top panel 120 in the Z axis direction.

In a state in which the supports 130 and the vibrating element 140 are bonded on the negative side surface of the top panel 120 in the Z axis direction, the top panel 120 is vibrated by driving the vibrating element 140. According to the first embodiment, there are a case, in which a vibration in an audible range is generated in the top panel 120, and a case, in which a standing wave is generated in the top panel 120 by causing the top panel 120 to vibrate at a natural vibration frequency of the top panel 120. However, because the supports 130 and the vibrating element 140 are bonded on the top panel 120, it is preferable to determine the natural vibration frequency in consideration of support stiffness of the supports 130, a weight of the vibrating element 140 and the like, in practice.

The number of supports 130 is 4. On the negative side surface of the top panel 120 in the Z axis direction, two supports 130 are bonded along each long side of the top panel 120 extending in the Y axis direction. The two of the four supports 130 are located at the positive side in the X axis direction and other two supports 130 located at the negative side in the X axis direction. As illustrated in FIG. 2, the four supports 130 are arranged for two at the negative side and two at the positive side in the Y axis direction of both long sides.

Positive side ends of the supports 130 in the Z axis direction are bonded on the negative side surface of the top panel 120 in the Z axis direction, and negative side ends of the supports 130 in the Z axis direction are bonded on the positive side surface of the housing 110 in the Z axis direction. The top panel 120 is fixed to the housing 110 through the supports 130 as described above.

Through a control signal input from a drive controlling part that will be described later below, the support stiffness between the positive side end in the Z axis direction and the negative side end in the Z axis direction of the supports 130 can be switched between two levels. In a case where a frequency of a vibration to be generated in the top panel 120 is high, the support stiffness is set to be a first level because a larger amplitude can be obtained by increasing the support stiffness.

In a case where a frequency of a vibration to be generated in the top panel 120 is low, the support stiffness is set to be a second level, which is less than the first level, because a larger amplitude can be obtained by decreasing the support stiffness. The detailed configuration of the supports 130 will be described later below. Further, a relationship between the support stiffness and the amplitude will be described later below with reference to simulation results.

The vibrating element 140 is bonded on the negative side surface of the top panel 120 in the Z axis direction, at a positive side in the Y axis direction, along the short side extending in the X axis direction. The vibrating element 140 may be any element as long as it can generate both vibration in an audible range and vibration in an ultrasound frequency band. A piezoelectric element such as a piezo element may be used as the vibrating element 140, for example. The vibrating element 140 is an example of a first vibrating element.

The vibrating element 140 is driven in accordance with a first driving signal or a second driving signal output from a drive controlling part which will be described later. A frequency and an amplitude (intensity) of the vibration generated by the vibrating element 140 are set by the first driving signal or the second driving signal. Further, on/off of the vibrating element 140 is controlled in accordance with the first driving signal or the second driving signal.

The first driving signal is a driving signal that is input to the vibrating element 140 for generating, in the top panel 120, a natural vibration in an ultrasound frequency band. The second driving signal is a driving signal that is input to the vibrating element 140 for generating, in the top panel 120, a vibration in an audible range.

Here, for example, the audible range is a frequency band less than about 20 kHz and is a frequency band that can be sensed by humans. The ultrasound frequency band is a frequency band, which is higher than or equal to about 20 kHz, for example.

According to the electronic device 100 of the first embodiment, when a natural vibration in an ultrasound frequency band is generated in the top panel 120, the frequency at which the vibrating element 140 vibrates is equal to a number of vibrations per unit time (frequency) of the top panel 120. Accordingly, the vibrating element 140 is driven through the first driving signal so that the vibrating element 140 vibrates at a number of natural vibrations per unit time (natural vibration frequency) of the top panel 120.

When a vibration in the audible range is to be generated in the top panel 120, the vibrating element 140 is driven through the second driving signal.

Note that another vibrating element may be disposed along the short side located at the negative side in the Y axis direction in addition to the vibrating element 140. Then, the two vibrating elements 140 may be simultaneously driven to generate, in the top panel 120, the vibration at the natural vibration frequency.

The vibrating element 140 may be provided on a side surface or a front surface of the top panel 120.

The touch panel 150 is disposed on (the positive side in the Z axis direction of) the display panel 160 and is disposed under (the negative side in the Z axis direction of) the top panel 120. The touch panel 150 may be disposed on the lower surface of the top panel 120. The touch panel 150 is one example of a coordinate detector that detects a position (in the following, the position is referred to as a position of the manipulation input) at which the user of the electronic device 100 touches the top panel 120.

Various Graphic User Interface (GUI) buttons or the like (hereinafter referred to as GUI manipulation part(s)) are displayed on the display panel 160 located under the touch panel 150. Therefore, the user of the electronic device 100 ordinarily touches the top panel 120 by his or her fingertip in order to manipulate the GUI manipulation part.

The touch panel 150 is any coordinate detector as long as it can detect the position of the manipulation input on the top panel 120 performed by the user. The touch panel 150 may be a capacitance type coordinate detector or a resistance film type coordinate detector, for example. Here, the embodiment in which the touch panel 150 is a capacitance type coordinate detector will be described. The capacitance type touch panel 150 can detect the manipulation input performed on the top panel 120 even if there is a clearance gap between the touch panel 150 and the top panel 120.

Also, although the top panel 120 is disposed on the input surface side of the touch panel 150 in the described embodiment, the top panel 120 may be integrated with the touch panel 150. In this case, the surface of the touch panel 150 is equal to the surface of the top panel 120 illustrated in FIGS. 2 and 3, and the surface of the touch panel 150 constitutes the manipulation input surface. The top panel 120 illustrated in FIGS. 2 and 3 may be omitted. In this case, the surface of the touch panel 150 constitutes the manipulation input surface. In this case, a member having the manipulation input surface, may be vibrated at a natural vibration frequency of the member.

In a case where the touch panel 150 is of capacitance type, the touch panel 150 may be disposed on the top panel 120. In this case also, the surface of the touch panel 150 constitutes the manipulation input surface. Also, in the case where the touch panel 150 is of capacitance type, the top panel 120 illustrated in FIGS. 2 and 3 may be omitted. In this case also, the surface of the touch panel 150 constitutes the manipulation input surface. In this case, a member having the manipulation input surface, may be vibrated at a natural vibration frequency of the member.

The display panel 160 may be a display part that can display an image. The display panel 160 may be a liquid crystal display panel, an organic Electroluminescence (EL) panel or the like, for example. Inside the recessed portion 110A of the housing 110, the display panel 160 is arranged on (the positive side in the Z axis direction of) the substrate 170 using a holder or the like whose illustration is omitted.

The display panel 160 is driven and controlled by a driver Integrated Circuit (IC), which will be described later, and displays a GUI manipulation part, an image, characters, symbols, graphics, and/or the like in accordance with an operating state of the electronic device 100.

The substrate 170 is disposed inside the recessed portion 110A of the housing 110. The display panel 160 and the touch panel 150 are disposed on the substrate 170. The display panel 160 and the touch panel 150 are fixed to the substrate 170 and the housing 110 by a holder or the like (not shown).

On the substrate 170, a drive controlling apparatus, which will be described later, and various circuits and the like that are necessary for driving the electronic device 100 are mounted.

According to the electronic device 100 having the configuration as described above, when the user touches the top panel 120 with his or her fingertip and a movement of the user's fingertip is detected, a drive controlling part mounted on the substrate 170 drives the vibrating element 140 to generate, in the top panel 120, a vibration in the audible range or a vibration in the ultrasound frequency band. This frequency in the ultrasound frequency band is a resonance frequency of a resonance system including the top panel 120 and the vibrating element 140, and generates a standing wave in the top panel 120.

The electronic device 100 generates, in the top panel 120, a vibration in the audible range or a vibration in the ultrasound frequency band to provide a tactile sensation to the user through the top panel 120.

Next, a simulation model will be described for performing a simulation about a relationship between support stiffness and amplitude.

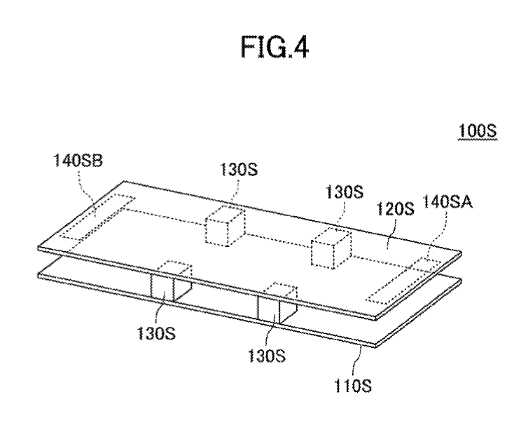

FIG. 4 is a diagram illustrating a simulation model. An electronic device 100S as the simulation model includes a housing 110S, a top panel 120S, supports 130S, and vibrating elements 140SA and 140SB as illustrated in FIG. 4. The housing 110S, the top panel 120S, the vibrating element 140SA respectively correspond to the housing 110, the top panel 120, and the vibrating element 140 illustrated in FIG. 2.

Although positions of the supports 130S correspond to those of the supports 130 illustrated in FIG. 2, here, support stiffness of the supports 130S is changed by using two kinds of materials having different Young's modulus rather than changing the support stiffness by the drive controlling part.

In the electronic device 100S, the top panel 120S is fixed on the plate shaped housing 110S through the four supports 130S. The vibrating elements 140SA and 140SB are attached to the back surface (lower side surface in FIG. 4) of the top panel 120S. The position of the vibrating element 140SA is equal to the position illustrated in FIG. 2. The vibrating element 140SB is arranged at a line-symmetric position of the vibrating element 140SA with respect to a central axis parallel to the two short sides of the top panel 120S in plan view.

In a case where two vibrating elements 140SA and 140SB are disposed as described above, the vibrating element 140SA is an example of a first vibrating element, and the vibrating element 140SB is an example of a second vibrating element.

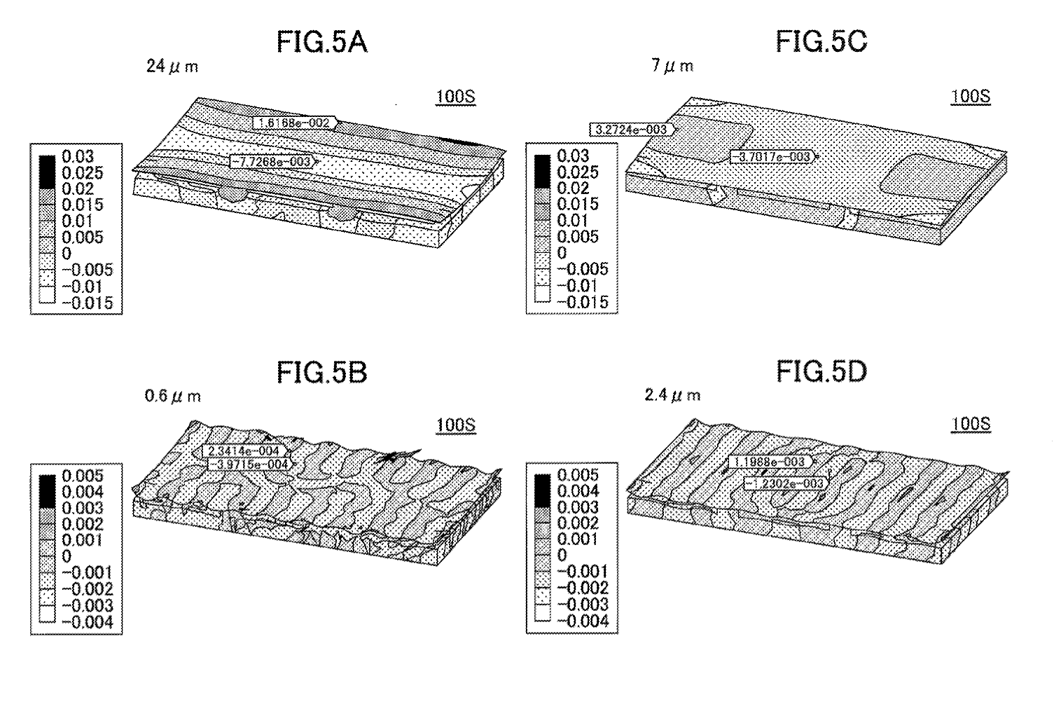

FIGS. 5A to 5D are diagrams illustrating simulation results. Two kinds of materials having different Young's modulus are used for materials of the supports 130S. Then, amplitudes of vibrations are obtained by driving the vibrating elements 140SA and 140SB to generate, in the top panel 120S, a vibration in the audible range and a natural vibration in the ultrasound frequency band. In FIGS. 5A to 5D, the amplitude is large in areas indicated in black, and the amplitude is small in areas indicated in white.

FIG. 5A illustrates a distribution of amplitude in a case where a vibration in the audible range is generated in the top panel 120S by using the supports 130S made of silicone rubber. FIG. 5B illustrates a distribution of amplitude in a case where a natural vibration in the ultrasound frequency band is generated in the top panel 120S by using the supports 130S made of silicone rubber. Note that Young's modulus of the silicone rubber is set to be 2.6×10⁶ (Pa).

FIG. 5C illustrates a distribution of amplitude in a case where a vibration in the audible range is generated in the top panel 120S by using the supports 130S made of acrylonitrile butadiene styrene resin (ABS resin). FIG. 5D illustrates a distribution of amplitude in a case where a natural vibration in the ultrasound frequency band is generated in the top panel 120S by using the supports 130S made of acrylonitrile butadiene styrene resin (ABS resin). Note that Young's modulus of the ABS resin is set to be 2.0×10⁹ (Pa).

In comparing FIG. 5A with FIG. 5C, the maximum amplitude in FIG. 5A is about 24 μm, and the maximum amplitude is about 7 μm in FIG. 5C. It is found from these results that, when the vibration in the audible range is generated in the top panel 120S, a larger amplitude can be obtained by using the supports 130SA, made of silicone rubber of which Young's modulus is low, than that obtained by using the supports 130S, made of ABS resin of which Young's modulus is high.

In comparing FIG. 5B with FIG. 5D, the maximum amplitude in FIG. 5B is about 0.6 μm, and the maximum amplitude of the standing wave is about 2.4 μm in FIG. 5D. It is found from these results that, when the natural vibration in the ultrasound frequency band is generated in the top panel 120S, a larger amplitude can be obtained by using the supports 130SA, made of ABS resin of which Young's modulus is high, than that obtained by using the supports 130S, made of silicone rubber of which Young's modulus is low.

As described above, it is found that the amplitude of the vibration generated in the top panel 120S can be increased by setting Young's modulus of the supports 130S to be lower when a vibration in the audible range is generated in the top panel 120S, and by setting Young's modulus of the supports 130S to be higher when a natural vibration in the ultrasound frequency band is generated in the top panel 120S.

In other words, it is revealed that a tactile sensation through a vibration in the audible range becomes easy to be sensed when the support stiffness of the supports 130S is low, and a tactile sensation through a natural vibration in the ultrasound frequency band becomes easy to be sensed when the support stiffness of the supports 130S is high.

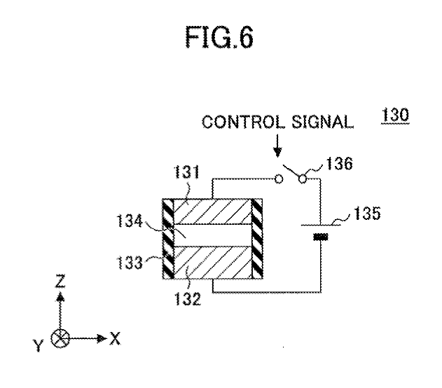

Next, the supports 130 will be described with reference to FIG. 6.

FIG. 6 is a diagram illustrating a structure of the support 130. FIG. 6 illustrates a cross sectional structure of the support 130.

The support 130 includes an electrode 131, an electrode 132, a housing 133, and an Electro-Rheological (ER) fluid. An upper surface of the electrode 131 is bonded on the negative side surface of the top panel 120 in the Z axis direction. A lower surface of the electrode 132 is bonded on the positive side surface of the recessed portion 110A of the housing 110. The electrode 131 and the electrode 132 are respectively an example of a first support part and an example of a second support part. Note that FIG. 6 illustrates the sane XYZ coordinate system as that of FIG. 3B.

The electrode 131 and the electrode 132 seal the top and bottom of the cylindrical housing 133, respectively. The ER fluid 134 is enclosed in an internal space formed by the electrode 131, the electrode 132, and the housing 133. For example, aluminum, copper, iron materials plated with nickel-chrome, or the like may be used for the electrode 131 and the electrode 132. The housing 133 may be formed of a resin such as silicone rubber.

A power source 135 and a switch 136 are coupled to the electrodes 131 and 132. The switch 136 is switched on/off through a control signal output from the drive controlling part, which will be described later below.

The ER fluid 134 is a fluid of which the viscosity is changed by an applied electric field. When an electric field is not applied in a state in which the switch 136 is off (non-conductive), the viscosity of the ER fluid 134 is low. On the other hand, when an electric field is applied by the power source 135 in a state in which, the switch 136 is on (conductive), the viscosity of the ER fluid 134 increases.

In the support 130, which encloses such an ER fluid 134, the support stiffness between the electrodes 131 and 132 of the support 130 can be changed by switching on/off of the switch 136. The support stiffness is increased by turning on the switch 136, and the support stiffness is decreased by turning off the switch 136.

Further, the ER fluid 134 has characteristics of increasing, in accordance with increasing of an applied electric field, its resistance to external force in a shearing direction. Here, the external force in the shearing direction is an external force applied in a direction where the electrodes 131 and 132 are displaced in the X axis direction and the Y axis direction.

When the electric field applied to the ER fluid 134 is small, in addition to displacement whereby the interval narrows between the electrodes 131 and 132 in the Z axis direction, the support 130 can be displaced such that the electrodes 131 and 132 are displaced in the X axis direction and the Y axis direction. For example, with respect to the displacement of the supports 130 in the Z axis direction, the electronic device 100 sets the support stiffness of the supports 130 to be higher in a case of generating a natural vibration in an ultrasound frequency band on the top panel 120. At this time, the support stiffness is of the first level. In a case of generating a vibration in an audible range on the top panel 120, the electronic device 100 sets the support stiffness of the supports 130 to be lower. At this time, the support stiffness is of the second level.

The support stiffness of the first level may be a high value such that the natural vibration in the ultrasound frequency band can be generated in the top panel 120 by driving the vibrating element 140, and may be a value about 2.0×10⁹ (Pa), for example.

The support stiffness of the second level may be a low value such that the vibration in the audible range can be generated in the top panel 120 by driving the vibrating element 140, and may be a value about 2.6×10⁶ (Pa), for example.

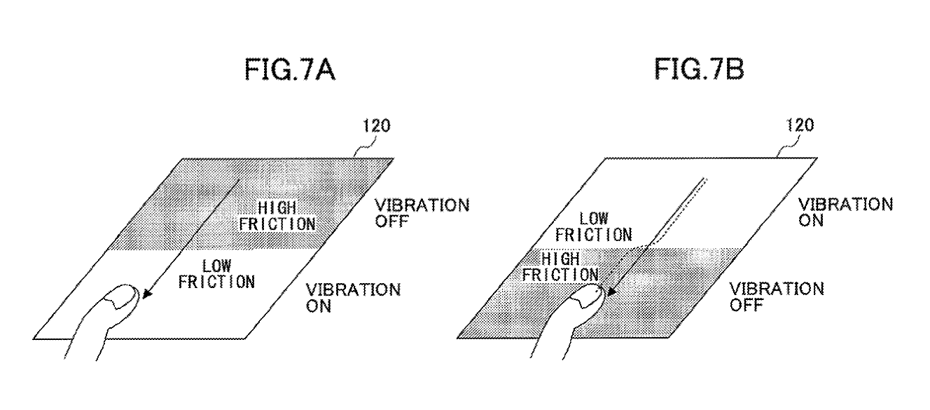

Next, the natural vibration in the ultrasound frequency band generated in the top panel 120 of the electronic device 100 will be described with reference to FIGS. 7A and 7B.

FIGS. 7A and 7B are diagrams illustrating cases where a kinetic friction force applied to the user's fingertip performing a manipulation input is varied by the natural vibration in the ultrasound frequency band generated in the top panel 120 of the electronic device 100. In FIGS. 7A and 7B, while touching the top panel 120 with the user's fingertip, the user performs the manipulation input by moving his or her fingertip along an arrow from a far side to a near side of the top panel 120. It should be noted that the vibration is turned on/off by turning on/off the vibrating element 140 (see FIGS. 2 and 3).

In FIGS. 7A and 7B, areas which the user's fingertip touches while the vibration is turned off are indicated in grey, with respect to the depth direction of the top panel 120. Areas which the user's finger touches while the vibration is turned on are indicated in white, with respect to the depth direction of the top panel 120.

As illustrated in FIG. 5, the natural vibration in the ultrasound frequency band occurs in the entire top panel 120. FIGS. 7A and 7B illustrate operation patterns in which on/off of the vibration is switched while the user's finger is tracing the top panel 120 from the far side to the near side.

Accordingly, in FIGS. 7A and 7B, the areas which the user's finger touches while the vibration is off are indicated in grey, and the areas which the user's finger touches while the vibration is on are indicated in white.

In the operation pattern illustrated in FIG. 7A, the vibration is off when the user's finger is located on the far side of the top panel 120, and the vibration is turned on in the process of moving the user's finger toward the near side.

Conversely, in the operation pattern illustrated in FIG. 7B, the vibration is on when the user's finger is located on the far side of the top panel 120, and the vibration is turned off in the process of moving the user's finger toward the near side.

Here, when the natural vibration in the ultrasound frequency band is generated in the top panel 120, a layer of air is interposed between the surface of the top panel 120 and the user's finger. The layer of air is provided by a squeeze film effect. Thus, a kinetic friction coefficient on the surface of the top panel 120 is decreased when the user traces the surface with the user's finger.

Accordingly, in the grey area located on the far side of the top panel 120 illustrated in FIG. 7A, the kinetic friction force applied to the user's fingertip increases. In the white area located on the near side of the top panel 120, the kinetic friction force applied to the user's fingertip decreases.

Therefore, a user who is performing the manipulation input on the top panel 120 as illustrated in FIG. 7A senses a decrease of the kinetic friction force applied to the user's fingertip when the vibration is turned on. As a result, the user senses a slippery or smooth touch (texture) with the user's fingertip. In this case, the user senses as if a concave portion on the surface of the top panel 120 were present on the surface of the top panel 120, when the surface of the top panel 120 becomes more slippery and the kinetic friction force decreases.

Conversely, in the white area located on the far side of the top panel 120 illustrated in FIG. 7B, the kinetic friction force applied to the user's fingertip decreases. In the grey area located on the near side of the top panel 120, the kinetic friction force applied to the user's finger tip increases.

Therefore, a user who is performing the manipulation input on the top panel 120 as illustrated in FIG. 7B senses an increase of the kinetic friction force applied to the user's fingertip when the vibration is turned off. As a result, the user senses a grippy or scratchy touch (texture) with the user's fingertip. In this case, the user senses as if a convex portion were present on the surface of the top panel 120, when the surface of the top panel 120 becomes grippy and the kinetic friction force increases.

As described above, the user can feel a concavity and convexity with his or her fingertip in the cases as illustrated in FIGS. 7A and 7B. For example, “The Printed-matter Typecasting Method for Haptic Feel Design and Sticky-band Illusion” (the Collection of papers of the 11th SICE system integration division annual conference (S12010, Sendai)_174-177, 2010-12) discloses that a person can sense a concavity or a convexity through a change of friction feeling. “Fishbone Tactile Illusion” (Collection of papers of the 10th Congress of the Virtual Reality Society of Japan (September, 2005)) discloses that a person can sense a concavity or a convexity as well.

Although a variation of the kinetic friction force when the vibration is switched on/off is described above, a variation of the kinetic friction force similar to that described above is obtained when the amplitude (intensity) of the vibrating element 140 is varied.

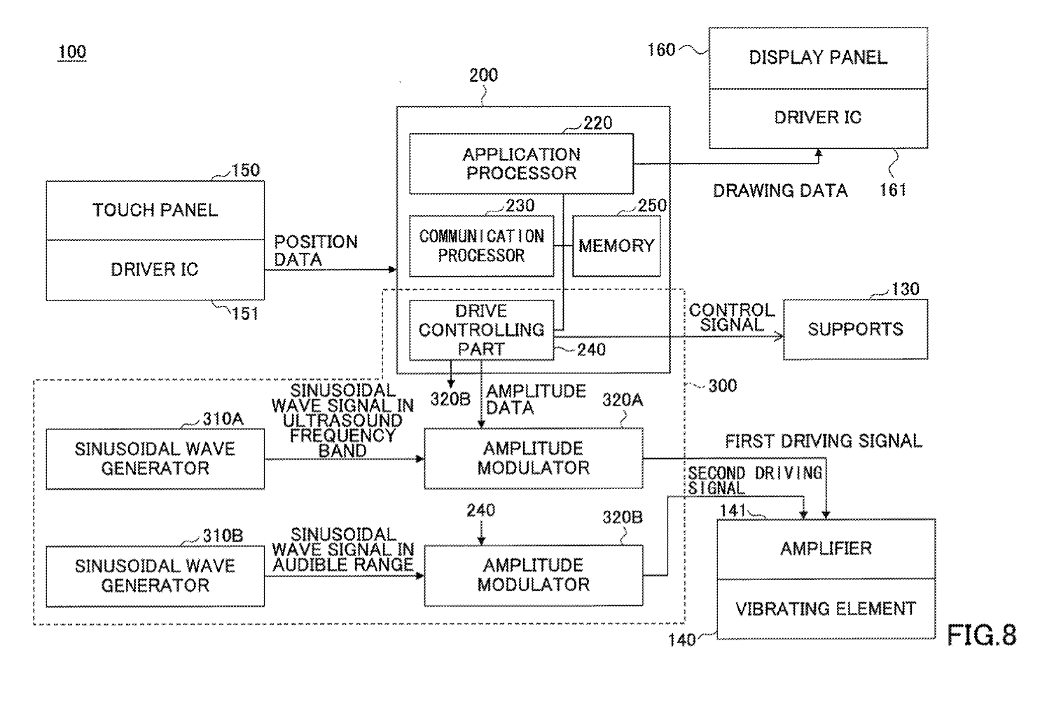

Next, a configuration of the electronic device 100 of the first embodiment will be described with reference to FIG. 8.

FIG. 8 is a diagram illustrating the configuration of the electronic device 100 of the first embodiment.

The electronic device 100 includes the supports 130, the vibrating element 140, an amplifier 141, the touch panel 150, a driver Integrated Circuit (IC) 151, the display panel 160, a driver IC 161, a controlling part 200, a sinusoidal wave generator 310A, a sinusoidal wave generator 310B, an amplitude modulator 320A, and an amplitude modulator 320B.

The controlling part 200 includes an application processor 220, a communication processor 230, a drive controlling part 240, and a memory 250. The controlling part 200 is realised by an IC chip, for example.

The drive controlling part 240, the sinusoidal wave generator 310A, the sinusoidal wave generator 310B, the amplitude modulator 320A, and the amplitude modulator 320B constitute a drive controlling apparatus 300. Here, although the embodiment, in which the application processor 220, the communication processor 230, the drive controlling part 240, and the memory 250 are realised by the single controlling part 200, is described, the drive controlling part 240 may be disposed outside the controlling part 200 as another IC chip or a processor. In this case, data, which is necessary for drive control of the drive controlling part 240 among data stored in the memory 250, may be stored in a memory different from the memory 250 and may be provided inside the drive controlling apparatus 300.

In FIG. 8, the housing 110, the top panel 120, and the substrate 170 (see FIG. 2) are omitted. Here, the supports 130, the amplifier 141, the driver IC 151, the driver IC 161, the drive controlling part 240, the memory 250, the sinusoidal wave generator 310A, the sinusoidal wave generator 310B, the amplitude modulator 320A, and the amplitude modulator 320B will be described.

The supports 130 are coupled to the drive controlling part 240 of the drive controlling apparatus 300, and an electric field applied to the ER fluids 134 is controlled through a control signal output from the drive controlling part 240. The support stiffness of the supports 130 is controlled through the control signal.

When generating a natural vibration in the ultrasound frequency band in the top panel 120, the drive controlling part 240 sets the support stiffness of the supports 130 to be the first level. When generating a vibration in the audible range in the top panel 120, the drive controlling part 240 sets the support stiffness of the supports 130 to be the second level.

The amplifier 141 is disposed between the drive controlling apparatus 300 and the vibrating element 140. The amplifier 141 amplifies the first driving signal or the second driving signal, output from the drive controlling apparatus 300, to drive the vibrating element 140.

The driver IC 151 is coupled to the touch panel 150. The driver IC 151 detects position data representing a position on the touch panel 150 at which a manipulation input is performed, and outputs the position data to the controlling part 200. As a result, the position data is input to the application processor 220 and the drive controlling part 240. Note that inputting the position data to the drive controlling part 240 is equivalent to inputting the position data to the drive controlling apparatus 300.

The driver IC 161 is coupled to the display panel 160. The driver IC 161 inputs drawing data, output from the drive controlling apparatus 300, to the display panel 160 and causes the display panel 160 to display an image that is based on the drawing data. In this way, a GUI manipulation part, an image, or the like based on the drawing data is displayed on the display panel 160.

The application processor 220 performs processing of executing various applications of the electronic device 100. The application processor 220 is an example of an application controlling part.

The communication processor 230 executes necessary processing so that the electronic device 100 performs communications such as 3G (Generation), 4G (Generation), LTE (Long Term Evolution), and WiFi.

The drive controlling part 240 inputs amplitude data to the amplitude modulators 320 in accordance with presence/absence of a manipulation input, and a distance of movement of a position of the manipulation input. The amplitude data is data representing an amplitude value for adjusting an intensity of the first driving signal and the second driving signal, used to drive the vibrating element 140.

In a case where an application during execution is an application that generates the natural vibration in the ultrasound frequency band in the top panel 120, the drive controlling part 240 switches on/off the vibrating element 140 using the first driving signal when a manipulation input is performed within a display area of a displayed GUI manipulation part or the like and an amount of movement of a position of the manipulation input reaches a unit amount of manipulation (unit distance of manipulation) of the GUI manipulation part or the like. This is in order to cause the user to sense the amount of manipulation through the tactile sensation because the kinetic friction force applied to the user's fingertip varies when on/off of the natural vibration in the ultrasound frequency band generated in the top panel 120 is switched.

In a case where an application during execution is an application that generates the vibration in the audible range in the top panel 120, the drive controlling part 240 switches on/off the vibrating element 140 using the second driving signal when a manipulation input is performed within a display area of a displayed GUI manipulation part or the like and an amount of movement of a position of the manipulation input reaches a unit amount of manipulation (unit distance of manipulation) of the GUI manipulation part or the like. This is in order to cause the user to sense the amount of manipulation through the tactile sensation of the vibration in the audible range by switching on/off of the vibration of the top panel 120.

Here, a position of a GUI manipulation part displayed on the display panel 160, of an area for displaying an image, of an area representing an entire page or the like on the display panel 160 is specified by area data that represents the area. The area data is provided, in all applications, with respect to all GUI manipulation parts to be displayed on the display panel 160, the area for displaying an image, or the area representing the entire page. A displaying state of the display panel 160 differs depending on the type of application. Therefore, area data is assigned to respective types of applications.

The drive controlling part 240 uses the area data to determine whether a position represented by position data input from the driver IC 151 is within a predetermined area in which a vibration is to be generated. This is in order to determine whether a GUI manipulation part is manipulated in each application, because all GUI manipulation parts to be displayed on the display panel 160 vary depending on applications.

The memory 250 stores control data. The control data associates data that represents types of applications with, area data that represents coordinate values of areas where a GUI manipulation part or the like is displayed on which a manipulation input is to be performed, pattern data that represents vibration patterns, and data that represents predetermined distances D. Note that the predetermined distances D will be described later below.

Further, the memory 250 stores programs and data necessary for the application processor 220 to execute the applications, and stores programs and data necessary for communicating processing of the communication processor 230, and the like.

The sinusoidal wave generator 310A generates sinusoidal waves required for generating the first driving signal that is for vibrating the top panel 120 at the natural vibration frequency in the ultrasound frequency band. Far example, in a case of causing the top panel 120 to vibrate at 33.5 kHz for the natural vibration frequency f, a frequency of the sinusoidal waves becomes 33.5 kHz. The sinusoidal wave generator 310A inputs a sinusoidal wave signal in the ultrasound frequency band to the amplitude modulator 320A. Note that the frequency of the sinusoidal waves may be about 20 kHz to 50 kHz for generating the natural vibration in the ultrasound frequency band in the top panel. 120.

The sinusoidal wave generator 310B generates sinusoidal waves required for generating the second driving signal that is for vibrating the top panel 120 in the audible range. For example, in a case of causing the top panel 120 to vibrate at 300 Hz for the natural vibration frequency f, a frequency of the sinusoidal waves is 300 Hz. The sinusoidal wave generator 310B inputs a sinusoidal wave signal in the audible range to the amplitude modulator 320B. Note that the frequency of the sinusoidal waves may be about 50 Hz to 300 Hz for generating the vibration in the audible range in the top panel 120.

Using the amplitude data input from the drive controlling part 240, the amplitude modulator 320A modulates an amplitude of the sinusoidal wave signal in the ultrasound frequency band, input from the sinusoidal wave generator 310A, to generate the first driving signal. The amplitude modulator 320A modulates only the amplitude of the sinusoidal wave signal in the ultrasound frequency band input from the sinusoidal wave generator 310A to generate the first driving signal without modulating a frequency and a phase of the sinusoidal wave signal.

The first driving signal output from the amplitude modulator 320 is a sinusoidal wave signal in the ultrasound frequency band obtained by modulating only the amplitude of the sinusoidal wave signal in the ultrasound frequency band input from the sinusoidal wave generator 310A. It should be noted that in a case where the amplitude data is zero, the amplitude of the driving signal is zero. This is the same as the amplitude modulator 320A not outputting the first driving signal.

Using the amplitude data input from the drive controlling part 240, the amplitude modulator 320B modulates an amplitude of the sinusoidal wave signal in the audible range input from the sinusoidal wave generator 310B to generate the second driving signal. The amplitude modulator 320B modulates only the amplitude of the sinusoidal wave signal in the audible range input from the sinusoidal wave generator 310B to generate the second driving signal without modulating a frequency and a phase of the sinusoidal wave signal.

The second driving signal output from the amplitude modulator 320B is a sinusoidal wave signal in the audible range obtained by modulating only the amplitude of the sinusoidal wave signal in the audible range input from the sinusoidal wave generator 310B. It should be noted that in a case where the amplitude data is zero, the amplitude of the second driving signal is zero. This is the same as the amplitude modulator 320B not outputting the second driving signal.

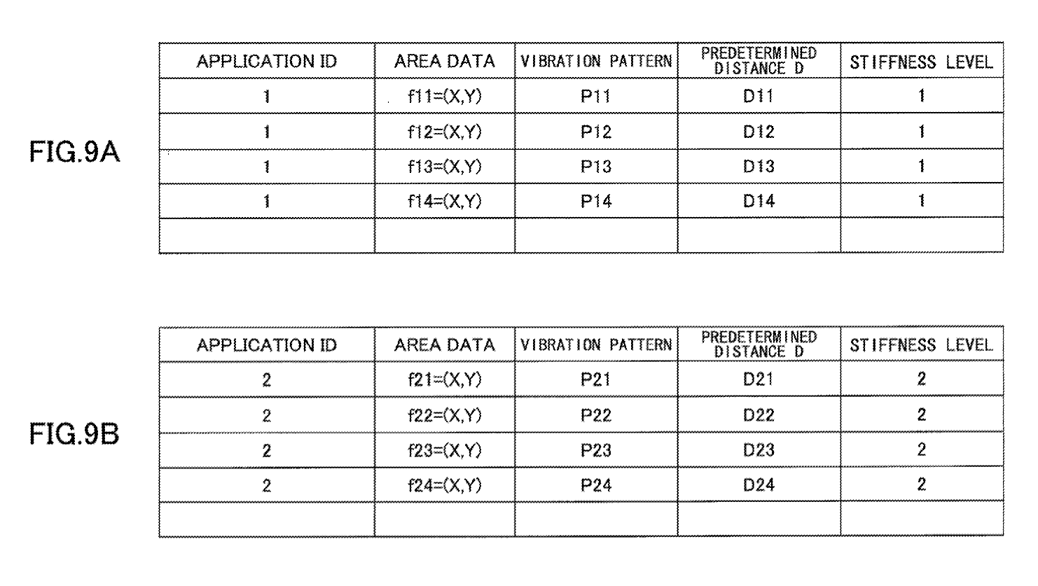

Next, the control data stored in the memory 250 will be described with reference to FIGS. 9A and 9B.

FIGS. 9A and 9B are diagrams illustrating the control data stored in the memory 250.

The control data illustrated in FIG. 9A is data used to generate a control signal of the first level and the first driving signal for generating, in the top panel 120, the natural vibration in the ultrasound frequency band. The control data illustrated in FIG. 9B is data used to generate a control signal of the second level and the second driving signal for generating, in the top panel 120, the vibration in the audible range.

As illustrated in FIGS. 9A and 9B, the control data stored in the memory 250 are data, which associate data representing types of respective applications, with area data representing coordinate values of areas where a GUI manipulation part or the like on which a manipulation input is to be performed is displayed, pattern data representing vibration patterns, data representing predetermined distances D, and data representing stiffness levels.

FIG. 9A illustrates application ID (Identification) as data representing a type of application. ID1 represents ID of the application for generating the natural vibration in the ultrasound frequency band in the top panel 120.

Further, FIG. 9A illustrates formulas f11 to f14 as the area data, representing coordinate values of areas where a GUI manipulation part or the like, on which a manipulation input is to be performed, is displayed. Further, FIG. 9A illustrates P11 to P14 as the pattern data, representing vibration patterns. Further, FIG. 9A illustrates D11 to D14 as the distance data, representing predetermined distances D.

The pattern data P11 to P14 can be mainly divided into two types, for example. The first, pattern data represents a driving pattern whereby the vibrating element 140 is on before an amount of movement of a position of a manipulation input has reached a unit amount of manipulation of a GUI manipulation part or the like and the vibrating element 140 is turned off at the time when the amount of movement of the position of the manipulation input has reached the unit amount of manipulation of the GUI manipulation part or the like. The second pattern data represents a driving pattern whereby the vibrating element 140 is off before an amount of movement of a position of a manipulation input has reached a unit amount of manipulation of a GUI manipulation part or the like and the vibrating element 140 is turned on at the time when the amount of movement of the position of the manipulation input has reached the unit amount of manipulation of the GUI manipulation part or the like.

The first pattern data represents the driving pattern for giving, to the user's fingertip, a tactile sensation of touching a convex portion by switching the vibration of the top panel 120 from on to off when the amount of movement of the position of the manipulation input reaches the unit amount of manipulation of the GUI manipulation part or the like.

The second pattern data represents the driving pattern for giving, to the user's fingertip, a tactile sensation of touching a concave portion by switching the vibration of the top panel 120 from off to on when the amount of movement of the position of the manipulation input reaches the unit amount of manipulation of the GUI manipulation part or the like.

As described above, the vibration pattern represents switching the vibration of the top panel 120 from on to off or switching the vibration of the top panel 120 from off to on when the amount of movement of the position of the manipulation input reaches the unit amount of manipulation of the GUI manipulation part or the like.

Further, the vibration pattern represents an amplitude at the time of turning on the vibration as described above. The data representing the amplitude represented by the vibration pattern is output from the drive controlling part 240 as the amplitude data.

The distance data D1 to D14 representing the predetermined distances D are data representing unit amounts of manipulation of a dial-type or slide-type GUI manipulation part. The unit amount of manipulation is a distance necessary for performing a manipulation input as a minimum unit on the dial-type or the slide-type GUI manipulation input. The minimum unit corresponds to one interval between scale marks adjacent to each other. That is, for example, in a case where the GUI manipulation is the slider 102B, the unit amount of manipulation corresponds to a distance (distance of one interval) between respective scale marks of the slider 102B.

The distance data D11 to D14 representing the predetermined distances D are set for the respective area data f11 to f14. This is because the amount of manipulation of minimum unit (corresponding to one interval) differs depending on the GUI manipulation part specified by the area data f11 to f14.

The data representing the stiffness levels are data representing levels of the support stiffness of the supports 130. The stiffness level is the first level or the second level. The stiffness level is “1” representing the first level because the control data illustrated in FIG. 9A is data used to generate the first driving signal for generating the natural vibration in the ultrasound frequency band in the top panel 120 and generate the control signal of the first level.

Note that applications represented by application IDs included in the control data stored in the memory 250 may include all applications usable by a smartphone terminal device or a tablet computer.

FIG. 9B illustrates application ID as the data representing a type of application. Further, FIG. 9B illustrates formulas f21 to f24 as the area data, representing coordinate values of areas where a GUI manipulation part or the like, on which a manipulation input is to be performed, is displayed. Further, FIG. 9B illustrates P21 to P24 as the pattern data, representing vibration patterns. Further, FIG. 9B illustrates D21 to D24 as the distance data, representing predetermined distances D. FIG. 9B illustrates the data representing the stiffness level.

ID2 represents ID of the application for generating the vibration in the audible range in the top panel 120. The stiffness level is “2” representing the second level because the control data illustrated in FIG. 9B is data used to generate the second driving signal for generating the vibration in the audible range in the top panel 120 and generate the control signal of the second level.

Other than differences in data values, the area data, the vibration patterns, and the predetermined distances D illustrated in FIG. 9B are respectively similar to the area data, the vibration patterns, and the predetermined distances D illustrated in FIG. 9A.

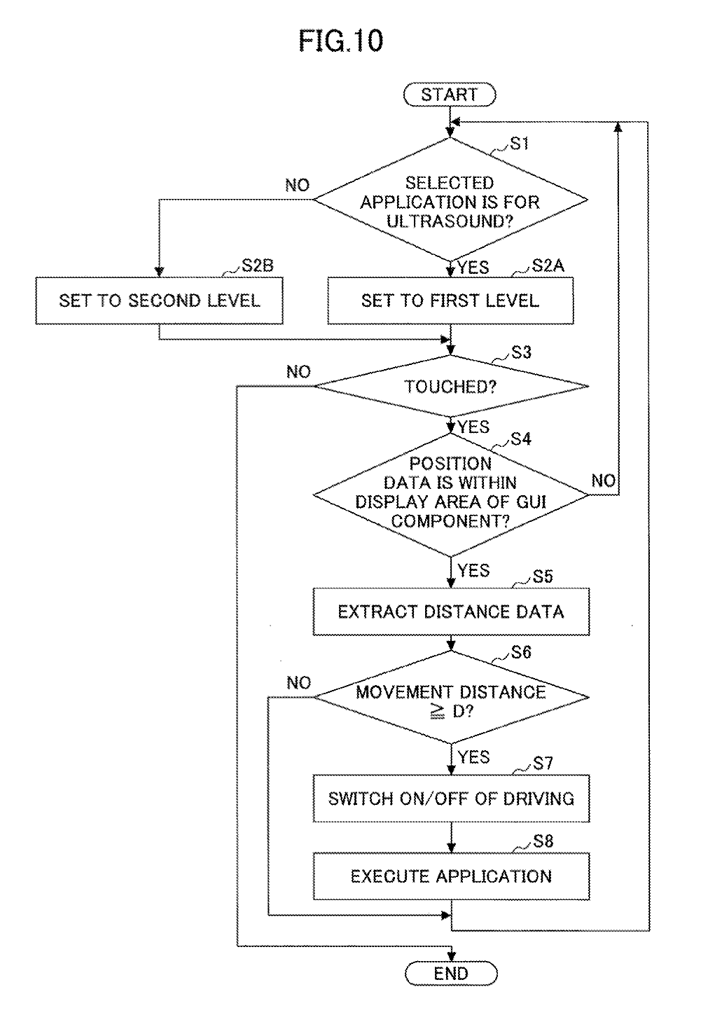

Next, processing that is executed by the drive controlling part 240 of the drive controlling apparatus 300 of the electronic device 100 according to the first embodiment will be described with reference to FIG. 10.

FIG. 10 is a diagram illustrating a flowchart illustrating the processing that is executed by the drive controlling part 240 of the drive controlling apparatus 300 of the electronic device 100 according to the first embodiment.

An operating system (OS) of the electronic device 100 executes control for driving the electronic device 100 every predetermined control cycle. Accordingly, the drive controlling apparatus 300 performs calculation for every predetermined control cycle. The same applies to the drive controlling part 240. The drive controlling part 240 repeatedly executes the flow as illustrated in FIG. 10 for every predetermined control cycle.

Here, when a required period of time, from a point of time when position data is input from the driver IC 151 to the drive controlling apparatus 300 to a point of time when a driving signal is calculated by the drive controlling part 240 based on the position data, is Δt, the required period Δt of time is substantially equal to the control cycle.

A period of time of one cycle of the predetermined control cycle can be treated as a period of time corresponding to the required period at of time, which is required from the point of time when the position data is input to the drive controlling apparatus 300 from the driver IC 151 to the point of time when the driving signal is calculated based on the position data.

The drive controlling part 240 starts the processing when the electronic device 100 is powered on.

The drive controlling part 240 determines whether a selected application is for generating a natural vibration in an ultrasound frequency band in step S1. Specifically, for example, the drive controlling part 240 may determine whether the application ID input from the application processor 220 is included in the control data illustrated in FIG. 9A for generating the natural vibration in the ultrasound frequency band or in the control data illustrated in FIG. 9B for generating the vibration in the audible range. Note that, the application processor 220 may identify the application ID based on the manipulation input performed on the touch panel 150.

Upon determining that the selected application is for generating the natural vibration in the ultrasound frequency band (YES in step S1), the drive controlling part 240 sets in step 52A the support stiffness of the supports 130 to be the first level based on the control data illustrated in FIG. 9A. After completing the process of step S2A, the drive controlling part 240 goes to step S3.

Upon determining that the selected application is not for generating the natural vibration in the ultrasound frequency band (NO in step S1), the drive controlling part 240 sets in step S2B the support stiffness of the supports 130 to be the second level based on the control data illustrated in FIG. 9B. After completing the process of step S2B, the drive controlling part 240 goes to step S3.

The drive controlling part 240 determines whether it is touched in step S3. The drive controlling part 240 may determine the presence/absence of the touch based on whether position data is input from the driver IC 151 (see FIG. 8).

In a case of determining that the touch is present (YES in step S3), the drive controlling part 240 determines, in accordance with coordinates represented by current position data and with a type of the current application, whether the coordinates represented by the current position data are within a display area of any GUI manipulation part or the like in step S4. The current position data represents coordinates on which a user currently performs the manipulation input.

Upon determining that the coordinates represented by the current position data are within the display area of any GUI manipulation part or the like (YES in step S4), the drive controlling part 240 extracts, from the control data, distance data that represents a predetermined distance D corresponding to the GUI manipulation part or the like including the coordinates represented by the current position data. The drive controlling part 240 sets extracted distance data as a value for determination in step S6.

The drive controlling part 240 determines whether a distance of movement of the position data is greater than or equal to the predetermined distance D in step S6. The distance of movement of the position data can be obtained by a difference between the position data, obtained in step S3 in the current control cycle, and the position data, obtained in step S3 in the previous control cycle.

Because the flow illustrated in FIG. 10 is repeatedly executed by the OS of the electronic device 100 for each control cycle, the drive controlling part 240 obtains the distance of movement of the position data based on the difference between the position data, obtained in step S3 in the current control cycle, and the position data, obtained in step S3 in the previous control cycle. Then, the drive controlling part 240 determines whether the obtained distance of movement of the position data is greater than or equal to the predetermined distance D.

Note that the distance of movement of the position data is not limited to a distance of movement in a case where the slider 102B is moved in one direction, but may be a distance of movement in a case where the slider 102B is returned in the opposite direction, for example. For example, in a case where the slider 102B is moved to the right from the left and thereafter returned to the left again, the distance of movement of returning to the left is also to be included.

In a case of determining that the distance of movement of the position data is greater than or equal to the predetermined distance D (YES in step S6), the drive controlling part 240 switches on/off of the vibrating element 140 by using the first driving signal or the second driving signal in step S7. The process of step S7 is a process for changing a tactile sensation provided to the user's fingertip by switching on/off of the vibrating element 140 when the amount of manipulation of the GUI manipulation part has reached the predetermined distance D corresponding to the unit amount of manipulation.

For example, it is possible to provide, to the user's fingertip, a tactile sensation of touching a convex portion in a case where the vibration of the vibrating element 140 is switched off from on. On the other hand, it is possible to provide, to the user's fingertip, a tactile sensation of touching a concave portion in a case where the vibration of the vibrating element 140 is switched on from off.

In this way, on/off of the vibrating element 140 is switched to switch the tactile sensation to be provided to the user's fingertip touching the top panel 120 so that the user senses, through the tactile sensation, that the amount of manipulation reaches the unit amount of manipulation.

In step S7, the natural vibration in the ultrasound frequency band is generated in the top panel 120 when the first driving signal is used, and the vibration in the audible range is generated in the top panel 120 when the second driving signal is used.

The drive controlling part 240 causes the application processor 220 (see FIG. 8) to execute processing of the application in step S8. For example, in a case where the application currently executed displays the slider 102B as a volume switch for changing a volume of sound and the user performs a manipulation input for adjusting the volume, the application processor 220 adjusts the volume.

In a case of determining that the distance of movement of the position data is not greater than or not equal to the predetermined distance D (NO in step S6), the drive controlling part 240 returns the flow to step S3. Because the distance of movement, has not reached the predetermined distance D, the drive controlling part 240 does not switch on/off of the vibrating element 140.

In a case of determining that the coordinates represented by the current position data are not within the display area of any GDI manipulation part or the like (NO in step S4), the drive controlling part 240 returns the flow to step S3. Because the coordinates represented by the current position data are not within the display area of the GUI manipulation part, or the like, it is not necessary to switch on/off of the vibrating element 140 and it is not necessary to proceed to the processes of steps S5 and S6.

In a case of determining that touching did not occur (NO in step S3), the drive controlling part 240 completes the drive control that is based on the flow illustrated in FIG. 10 (END). In a case of driving the vibrating element 140, the drive controlling part 240 stops driving the vibrating element 140. In order to stop the vibrating element 140, the drive controlling part 240 sets the amplitude value of the driving signal to be zero.

Accordingly, by repeatedly executing the control processing illustrated in FIG. 10 for each control cycle, on/off of the vibration of the top panel 120 is switched every time the user's fingertip, touching the GUI manipulation part or the like, moves and the amount of manipulation has reached the unit amount of manipulation. In this way, the tactile sensation of touching a concave portion or a convex portion can be provided to the user's fingertip, and it is possible to cause the user to sense, through the tactile sensation, that the amount of manipulation has reached the unit amount of manipulation.

Further, every time the amount of manipulation reaches the unit amount of manipulation, the processing of the application is executed.

Then, when the user's fingertip separates from the top panel 120, all processing is completed.

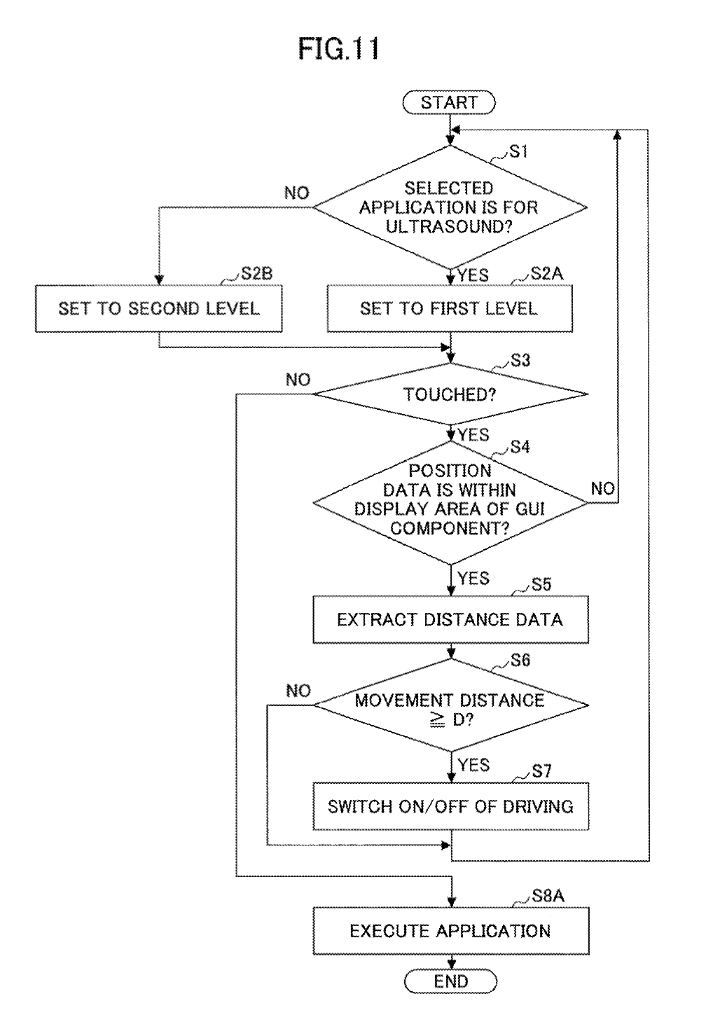

Although the processing based on the application is executed every time the amount of manipulation reaches the unit amount of manipulation in the control processing illustrated in the flowchart of FIG. 10, the processing based on application may be executed at a point of time at which the user's manipulation is completed. FIG. 11 illustrates a flow of such processing.

FIG. 11 is a flowchart illustrating processing that is executed by the drive controlling part 240 of the drive controlling apparatus 300 of the electronic device 100 according to the first embodiment.

Steps S3 to S7 of the flow illustrated in FIG. 11 are similar to steps S3 to S7 of the flow illustrated in FIG. 10.

In the flowchart illustrated in FIG. 11, the drive controlling part 240 returns the flow to step S3 upon completing the process of step S7. Then, in a case of determining that touching did not occur (NO in step S3), the flow proceeds to step S8A.

According to the flow illustrated in FIG. 11, the drive controlling part 240 causes the application processor (see FIG. 8) to execute the processing that is based on the application in step S8A after the manipulation input of the user is completed and his or her fingertip separates from the top panel 120.

Accordingly, by repeatedly executing the control processing illustrated in FIG. 11 for each control cycle, on/off of the vibration of the top panel 120 is switched every time the user's fingertip, touching the GUI manipulation part or the like, moves and the amount of manipulation has reached the unit amount of manipulation. This is similar to the processing illustrated in FIG. 10.

However, in the control processing illustrated in FIG. 11, the processing of the application is executed when the manipulation input of the user is completed and his or her fingertip separates from the top panel 120.

The drive controlling part 240 of the drive controlling apparatus 300 of the electronic device 100 according to the first embodiment controls driving of the vibrating element 140 based on either the control processing illustrated in FIG. 10 or the control processing illustrated in FIG. 11.

Note that in the control processing illustrated in FIG. 10 and FIG. 11, the distance data, representing the predetermined distances D included in the control data, are used to determine whether an amount of manipulation has reached a unit amount of manipulation. However, without using distance data representing predetermined distances D that are included in control data, on/off may be switched when the amount of manipulation moves by one predetermined distance D.

For example, in a case where one value is sufficient for the predetermined distance D or a case where the predetermined distance D for a plurality of GUI manipulation parts is a uniform value, the drive controlling part 240 may store the value representing the predetermined distance D as a fixed value without using the value of the predetermined distance D as the distance data included in the control data.

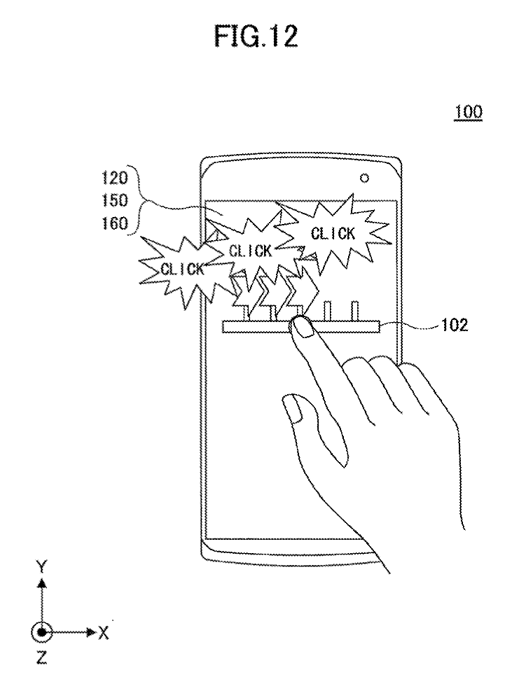

Next, operating examples of the electronic device 100 according to the first embodiment will be described with reference to FIG. 12 to FIG. 14.

FIG. 12 to FIG. 14 illustrate operating examples of the electronic device 100 according to the first embodiment. A XYZ coordinate system, similar to that of FIG. 2 and FIG. 3, is defined in FIG. 12 to FIG. 14. Here, for example, an embodiment will be described in which a natural vibration in the ultrasound frequency band is generated in the top panel 120 by the first driving signal. Note that in a case where the second driving signal is used, a vibration in the audible range is generated in the top panel 120.

FIG. 12 illustrates an operating mode for adjusting a predetermined level through the slider 102 in a state of executing a predetermined application. The slider 102 is structured to have five scale marks so that the level can be adjusted in five levels.

Here, it is assumed that before moving the slider 102, the user's fingertip touches the top panel 120 and the natural vibration is generated in the top panel 120. Therefore, the user's fingertip is in a slippery state.

Here, every time the slider 102 is moved to reach a scale mark, the vibration of the top panel 120 is turned off and the user's fingertip becomes grippy. Thereby, the vibrating element 140 is driven through a driving pattern for providing, to the user, a tactile sensation as if a convex portion were present on the surface of the top panel 120. The tactile sensation as if the convex portion were present is sensed by the user as a so-called click feeling.

A distance from the left end of the slider 102 to the first scale mark is equal to the distance between the respective scale marks. The predetermined distance D used in the determination of step S4 in the flowchart illustrated in FIG. 10 is set to be the distance between the scale marks (distance of one interval).

In such an operating mode, when the user drags the slider 102 with his or her fingertip from the left end to right to reach the third scale mark, the natural vibration of the top panel 120 is turned off by the drive controlling part 240 turning off the vibrating element 140 every time the slider 102 reaches the respective scale mark.

Accordingly, when the user moves his or her fingertip from the left end of the slider 102 to the first scale mark, to the second scale mark from the left, and to the third scale mark from the left, the drive controlling apparatus 300 provides to the user's fingertip tactile sensations as if convex portions were present.

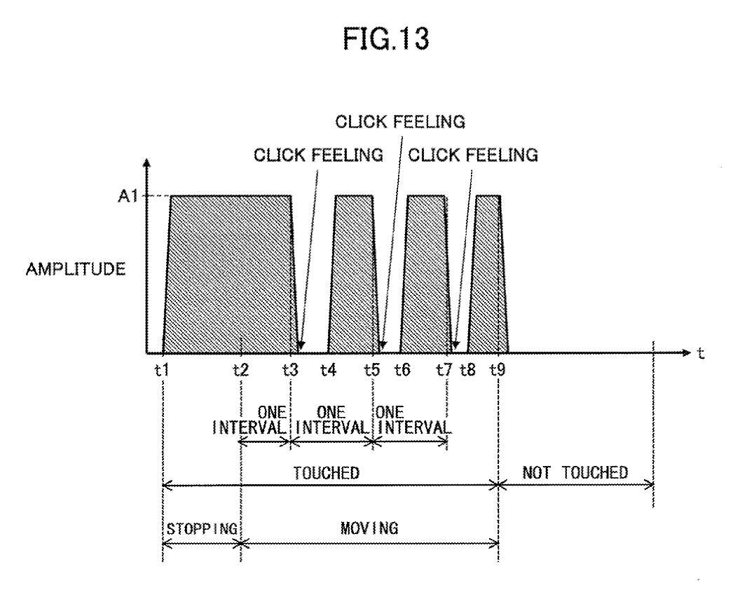

Here, this driving pattern will be described with reference to FIG. 13. In FIG. 13, the top panel 120 is vibrated at a natural vibration frequency of 33.5 kHz.

As illustrated in FIG. 13, when the user's fingertip touches the slider 102 at time t1, the vibrating element 140 is driven by the drive controlling part 240 to generate the natural vibration in the top panel 120. At this time, the natural vibration with amplitude A1 is generated in the top panel 120.

Then, the user's fingertip stops from time t1 to time t2. The natural vibration with amplitude A1 is generated in the top panel 120 between time t1 and time t2. When the user's fingertip starts to move at time t2 and reaches the first scale mark from the left at time t3, the distance of movement of the user's fingertip reaches the predetermined distance D. Then, the drive controlling part 240 turns off the vibrating element 140. Thus, the amplitude of the top panel 120 becomes zero immediately after time t3. The user can obtain the tactile sensation as if a convex portion were present on the surface of the top panel 120 through his or her fingertip and can recognize that the user's fingertip has reached the first scale mark from the left.

When the user continues to move the slider 102 to the right, the vibrating element 140 is driven by the drive controlling part 240 at time t4. Thereby, the natural vibration of amplitude A1 is generated in the top panel 120. Note that the length of time from time t3 to time t4, during which the driving signal of the vibrating element 140 is off, is 50 ms, for example.

Upon reaching the second scale mark from the left at time t5, the distance of movement of the user's fingertip reaches the predetermined distance D. Thereby, the drive controlling part 240 turns off the vibrating element 140. In this way, the amplitude of the top panel 120 becomes zero immediately after time t5. The user can obtain the tactile sensation as if a convex portion were present on the surface of the top panel 120 through his or her fingertip and can recognise that the user's fingertip has reached the second scale mark from the left.

When the user continues to move the slider 102 to the right, the vibrating element 140 is driven by the drive controlling part 240 at time t6. Thereby, the natural vibration of amplitude A1 is generated in the top panel 120. Note that, the length of time from time t5 to time t6, during which the driving signal of the vibrating element 140 is off, is 50 ms, for example.

Upon reaching the third scale mark from the left at time t7, the distance of movement of the user's fingertip reaches the predetermined distance D. Thereby, the drive controlling part 240 turns off the vibrating element 140. In this way, the amplitude of the top panel 120 becomes aero immediately after time t7. The user can obtain the tactile sensation as if a convex portion were present on the surface of the top panel 120 through his or her fingertip and can recognize that the user's fingertip has reached the third scale mark from the left.

When the user continues to move the slider 102 to the right, the vibrating element 140 is driven by the drive controlling part 240 at time t8. Thereby, the natural, vibration of amplitude A1 is generated in the top panel 120. Note that the length of time from time t7 to time t8, during which the driving signal of the vibrating element 140 is off, is 50 ms, for example,

When the user separates his or her fingertip from the top panel 120 at time t9, the drive controlling part 240 turns off the vibrating element 140. In this way, the amplitude of the top panel 120 becomes zero immediately after time t9.

Because the user does not touch the top panel 120 thereafter, a state continues in which the amplitude of the top panel 120 is zero and the top panel 120 does not vibrate.

As described, every time the user manipulates, with his or her fingertip, the slider 102 to reach one of the first, the second, and the third scale marks from the left, the drive controlling apparatus 300 can provide, to the user's fingertip, the tactile sensation as if a convex portion were present on the surface of the top panel 120.

Thus, by obtaining the tactile sensations as if convex portions were present on the surface of the top panel 120 through his or her fingertip, the user can recognise that his or her fingertip has reached the respective scale marks.

In FIG. 13, the vibrating element 140 is driven to generate the natural vibration in the top panel 120 when the user's fingertip touches the slider 102 at time t1. Further, the vibrating element 140 is turned off to provide the tactile sensation as if a convex portion were present on the surface of the top panel 120 when the distance of movement of the user's fingertip has reached the predetermined distance D.

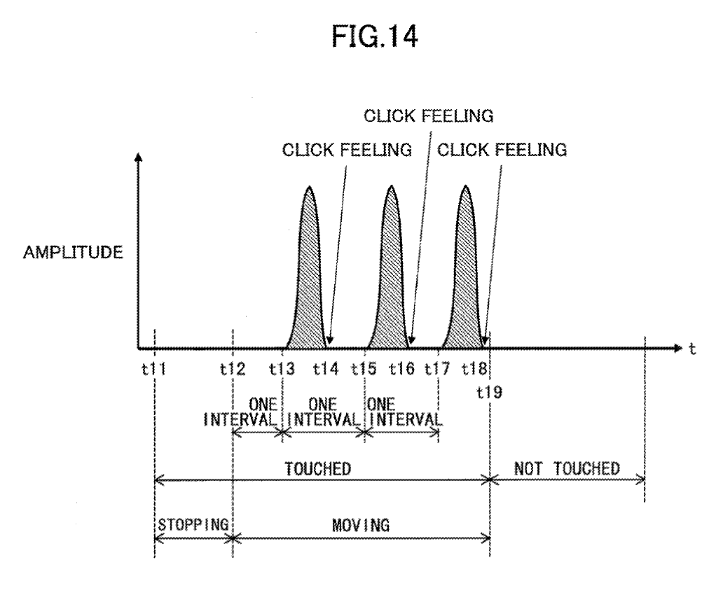

However, without generating the natural vibration in the top panel 120 when the user's fingertip touches the slider 103 at time t1, on/off of the driving pattern illustrated in FIG. 13 may be reversed. Such a driving pattern will be described with reference to FIG. 14.

As illustrated in FIG. 14, the user's fingertip touches the slider 102 at time t11. At this time, the drive controlling part 240 does not drive the vibrating element 140 and the natural vibration is not generated in the top panel 120.

Then, the user's fingertip stops from time t11 to time t12. A state, in which the natural vibration is not generated in the top panel 120, continues between time t11 and time t12. When the user's fingertip starts to move at time t12 and reaches the first scale mark from the left at time t13, the distance of movement of the user's fingertip reaches the predetermined distance D. Thereby, the drive controlling part 240 turns on the vibrating element 140. Thus, immediately after time t13, the amplitude of the top panel 120 begins rising. The amplitude of the top panel 120 somewhat gradually rises as illustrated in FIG. 14. The user can obtain a tactile sensation as if a concave portion were present on the surface of the top panel 120 through his or her fingertip.

When the user continues to move the slider 102 to the right, the vibrating element 140 is turned off by the drive controlling part 240 at time t14. Thereby, the vibration of the top panel 120 is turned off. In this way, the user can obtain the tactile sensation as if a convex portion were present on the surface of the top panel 120 through his or her fingertip. Note that the length of time from time t13 to time t14, during which the driving signal of the vibrating element 140 is on, is 100 ms, for example.

Because the difference between time t13 and time t14 is 100 ms, which is a very short length of time, the user can recognize that his or her fingertip has reached the first scale mark from the left by feeling a concavo-convex portion through his or her fingertip.

Upon reaching the second scale mark from the left at time t15, the distance of movement of the user's fingertip reaches the predetermined distance D. Thereby, the drive controlling part 240 turns on the vibrating element 140. Thus, immediately after time t15, the amplitude of the top panel 120 begins rising. In this way, the user can obtain the tactile sensation as if a concave portion were present on the surface of the top panel 120 through his or her fingertip.

When the user continues to move the slider 102 to the right, the vibrating element 140 is turned off by the drive controlling part 240 at time t16. Thereby, the vibration of the top panel 120 is turned off. In this way, the user can obtain the tactile sensation as if a convex portion were present on the surface of the top panel 120 through his or her fingertip. Note that the length of time from time t15 to time t16, during which the driving signal of the vibrating element 140 is on, is 100 ms, for example.

Because the difference between time t15 and time t16 is 100 ms, which is a very short length of time, the user can recognize that his or her fingertip has reached the second scale mark from the left by feeling a concavo-convex portion through his or her fingertip.

Upon reaching the third scale mark from the left at time t17, the distance of movement of the user's fingertip reaches the predetermined distance D. Thereby, the drive controlling part 240 turns on the vibrating element 140. Thus, immediately after time t17, the amplitude of the top panel 120 begins rising. In this way, the user can obtain the tactile sensation as if a concave portion were present on the surface of the top panel 120 through his or her fingertip.

When the user continues to move the slider 102 to the right, the vibrating element 140 is turned off by the drive controlling part 240 at time t18. Thereby, the vibration of the top panel 120 is turned off. In this way, the user can obtain the tactile sensation as if a convex portion were present on the surface of the top panel 120 through his or her fingertip. Note that the length of time from time t17 to time t18, during which the driving signal of the vibrating element 140 is on, is 100 ms, for example.

Because the difference between time t17 and time t18 is 100 ms, which is a very short length of time, the user can recognize that his or her fingertip has reached the third scale mark from the left by feeling a concavo-convex portion through his or her fingertip.

When the user separates his or her fingertip from the top panel 120 at time t19, the control processing by the drive controlling part 240 is completed.

Because the user does not touch the top panel 120 thereafter, a state continues in which the amplitude of the top panel 120 is zero and the top panel 120 does not vibrate.

As described, every time the user manipulates, with his or her fingertip, the slider 102 to reach one of the first, the second, and the third scale marks from the left, the drive controlling apparatus 300 can provide, to the user's fingertip, the tactile sensation as if a concavo-convex portion were present on the surface of the top panel 120.

Thus, by obtaining the tactile sensations as if concavo-convex portions were present on the surface of the top panel 120 through his or her fingertip, the user can recognize that his or her fingertip has reached the respective scale marks.

Note that, in the driving pattern illustrated in FIG. 14, a driving signal for raising the amplitude somewhat gradually at times t13, t15, and t17 is used. This is different from the driving pattern, illustrated in FIG. 13, for rectangularly raising the vibration at times t1, t4, t6, and t8. A way of raising the amplitude may be either a rectangular rising as illustrated in FIG. 13 or a gradual rising as illustrated in FIG. 14. For example, a driving signal that causes the amplitude to sinusoidally rise may be used for gradual rising as illustrated in FIG. 14.

Note that in the described operating examples illustrated in FIG. 12 to FIG. 14, the first driving signal is used to generate the natural vibration in the ultrasound frequency band in the top panel 120. However, when the second driving signal is used, a vibration in the audible range is generated in the top panel 120. When the vibration in the audible range is generated in the top panel 120, the squeeze film effect of decreasing the kinetic friction force is not obtained, but a tactile sensation can be similarly provided to the user's fingertip by the vibration in the audible range.

As described above, in a case of generating the natural vibration in the ultrasound frequency band in the top pane 120, the electronic device 100 according to the first embodiment drives the vibrating element 140 through the first driving signal for generating the natural vibration in the ultrasound frequency band after setting the level of the support stiffness of the supports 130 to be the first level (high level).

Hence, the natural vibration in the ultrasound frequency band of which the amplitude is large can be efficiently generated in the top panel 120, and the user can more easily feel the change of the kinetic friction force applied to his or her fingertip. Thus, it is possible to provide good tactile sensations to the user.

Further, in a case of generating the vibration in the audible range in the top panel 120, the electronic device 100 according to the first embodiment drives the vibrating element 140 through the second driving signal for generating the vibration in the audible range after setting the level of the support stiffness of the supports 130 to be the second level (low level).

Hence, the vibration in the audible range of which the amplitude is large can be efficiently generated in the top panel 120, and the user can more easily feel the vibration through his or her fingertip. Thus, it is possible to provide favorable tactile sensations to the user.

As described above, the electronic device 100 according to the first embodiment can increase both the amplitude of the natural vibration in the ultrasound frequency band and the amplitude of the vibration in the audible range by switching the level of the support stiffness of the supports 130. Thus, it is possible to provide the electronic device 100 that can provide various favorable tactile sensations.

Further, the electronic device 100 of the first embodiment generates the first driving signal by causing the amplitude modulator 320A to modulate only the amplitude of the sinusoidal wave in the ultrasound frequency band output from the sinusoidal wave generator 310A. The frequency of the sinusoidal wave in the ultrasound frequency band generated by the sinusoidal wave generator 310A is equal to the natural vibration frequency of the top panel 120. Further, the natural vibration frequency is set in consideration of the vibrating element 140.

That is, the first driving signal is generated by the amplitude modulator 320A modulating only the amplitude of the sinusoidal wave in the ultrasound frequency band generated by the sinusoidal wave generator 310A without modulating the frequency or the phase of the sinusoidal wave.

Accordingly, it becomes possible to generate, in the top panel 120, the natural vibration in the ultrasound frequency band of the top panel 120 and to decrease with certainty the kinetic friction coefficient applied to the user's finger tracing the surface of the top panel 120 by utilising the layer of air provided by the squeeze film effect. Further, it becomes possible to provide a favorable tactile sensation to the user as if a concavo-convex portion were present on the surface of the top panel 120 by utilising the Sticky-band Illusion effect or the Fishbone Tactile Illusion effect.

Further, the electronic device 100 of the first embodiment can generate the second driving signal by causing the amplitude modulator 320B to modulate only the amplitude of the sinusoidal wave in the audible range output from the sinusoidal wave generator 310B.

The driving method illustrated in FIG. 12 to FIG. 14 is described as a driving method for generating the natural vibration in the ultrasound frequency band in the top panel 120. However, the driving method illustrated in FIG. 12 to FIG. 14 is an example. Any driving method may be used as long as the driving method is for generating the natural vibration in the ultrasound frequency band in the top panel 120.

The electronic device 100 of the first embodiment may be a device that can generate both the natural vibration in the ultrasound frequency band and the vibration in the audible range. At that time, the device switches the level of the support stiffness of the supports 130 so that the large amplitude can be obtained in both the natural vibration in the ultrasound frequency band and the vibration in the audible range.

In the embodiment, described above, in order to provide the tactile sensations to the user as if concave-convex portions were present on the top panel 120, the vibrating element 140 is switched on/off. Turning off the vibrating element 140 is equal to setting the amplitude value, represented by the first driving signal or the second driving single used to drive the vibrating element 140, to zero.

However, it is not necessary to turn the vibrating element 140 from on to off in order to provide such tactile sensations. For example, the vibrating element 140 may be driven to decrease the amplitude instead of turning off the vibrating element 140. For example, similar to turning the vibrating element 140 from on to off, the electronic device 100 may provide the tactile sensation to the user as if a concavo-convex portion were present on the top panel 120 by decreasing the amplitude to about one-fifth.

In this case, the vibrating element 140 is driven by the first drive signal or the second driving signal such that the intensity of the vibration of the vibrating element 140 is changed. As a result, the intensity of the natural vibration or the vibration in the audible range generated in the top panel 120 is changed. It becomes possible to provide the tactile sensation to the user's fingertip as if a concavo-convex portion were present on the top panel 120 on the surface of the top panel 120.

If the vibrating element 140 is turned off when weakening the vibration in order to change the intensity of the vibration of the vibrating element 140, on/off of the vibrating element 140 is switched. Switching on/off of the vibrating element 140 means driving the vibrating element 140 intermittently. Such switching of the intensity of the natural vibration or the vibration in the audible range may be realized by changing the amplitude of the first driving signal or the second driving signal of driving the vibrating element 140, for example. The intensity of the natural vibration or the vibration in the audible range is increased by increasing the amplitude of the first driving signal or the second driving signal, and the intensity of the natural vibration or the vibration in the audible range is decreased by decreasing the amplitude of the first driving signal or the second driving signal. Instead of adjusting the amplitude of the first driving signal or the second driving signal or in addition to adjusting the amplitude, the duty cycle of the first driving signal or the second driving signal may be adjusted.

Although the four supports 130 are used to fix the top panel 120 to the housing 110 in the described embodiment, the number of supports 130 is not limited to four. Further, the positions of the supports 130 are not limited to the positions illustrated in FIG. 2. For example, wall shaped supports may be disposed along the four sides of the top panel 120.

In the above described embodiment, the support stiffness of the supports 130 is set to the first level or the second level when the vibrating element 140 is driven by using the first driving signal or the second driving signal, respectively.

However, in addition to the control as described above, for example, a tactile sensation (stroke feeling) of pressing a mechanical button, realised by a key dome, may be provided to the user's fingertip touching the top panel 120 by changing the support stiffness of the supports 130 in a case where the vibrating element 140 is not driven.

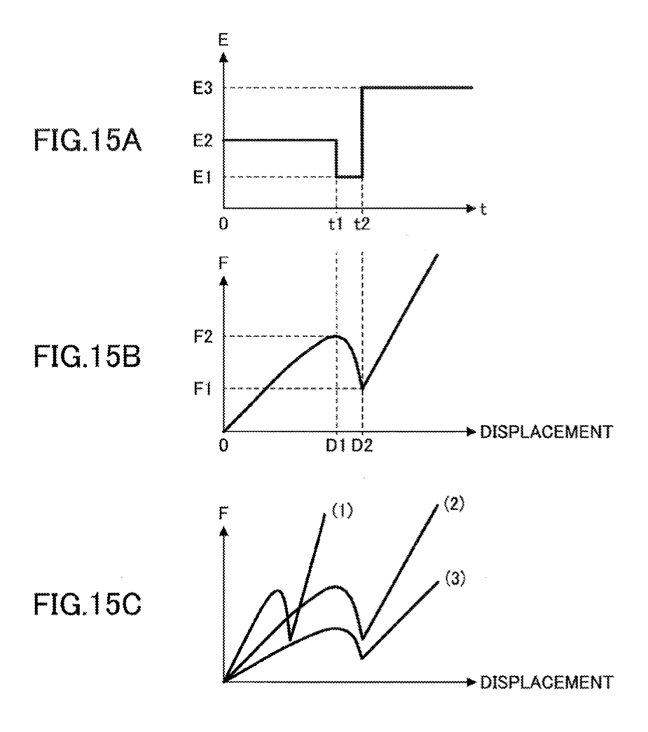

FIGS. 15A to 15C are diagrams illustrating a control pattern of the supports 130 for providing a stroke feeling, and a react ion force that expresses the stroke feeling.

In FIG. 15A, a horizontal axis represents time and a vertical axis represents electric field E that is applied between the electrodes 131 and 132 of the supports 130. Electric field E2 is applied between the electrodes 131 and 132 from time t0. Electric field E1 (<E2) is applied between the electrodes 131 and 132 at time t1. Electric field E3 (>E2) is applied between the electrodes 131 and 132 at time t2.

It is assumed that the user's fingertip starts to touch the manipulation input surface of the top panel 120 at time t0 in a case where the support stiffness of the supports 130 is controlled through such a control pattern.

In FIG. 15B, a horizontal axis represents a displacement of the position of the manipulation input. Here, in a case where an electric field applied to the ER fluid 134 is small, the support 130 can be displaced so that the electrodes 131 and 132 are displaced in the X axis direction and the Y axis direction in FIG. 3 in addition to the displacement of narrowing the interval between the electrodes 131 and 132. Hence, the horizontal axis of FIG. 15B represents the amount obtained by totaling all displacements in the X, Y, and Z axis directions.

Further, a vertical axis of FIG. 15B represents a reaction force F applied to the user's fingertip.

As illustrated in FIG. 15B, while the user's fingertip continues to press the top panel 120 from time t0, at which the displacement is zero, to time t1, at which the displacement is D1, the reaction force applied to the user's fingertip is substantially linearly increased to be F2. This is because the user's fingertip continuously pushes the top panel 120 in a state in which the electric field E2 is applied and the support stiffness of the supports 130 is constant.

Then, when the electric field decreases to E1 at time t1, the reaction force decreases to F1 (<F2) because the support stiffness of the supports 130 decreases.

When the electric field increases to E3 (>E2) at time t2, the reaction force F again increases from F1.

Such characteristics of the reaction force F are similar to a stroke feeling at a time of pushing a mechanical button realized by a key dome. Further, such characteristics are similar to a stroke feeling at a time of pushing a key of a mechanical keyboard. The button of the key dome and the key of the mechanical keyboard have characteristics, in which the reaction force is strong at the start of pushing, the reaction force weakens as a push determines a manipulation, and then the reaction force again strengthens because it becomes impossible to push any more after the manipulation is determined.

The characteristics of the reaction force illustrated in FIG. 15B are similar to characteristics of reaction force of the button of the key dome, the key of the mechanical keyboard, and the like.

Various characteristics such as (1), (2), and (3) of reaction force as illustrated in FIG. 15C can be realised by selecting timing(s) of changing the electric field applied between the electrodes 131 and 132 of the supports 130 and values of the electric field before and after the change(s).

Hence, in a case where the vibrating element 140 is not driven, the support stiffness of the supports 130 may be changed as described above to provide, to the user's fingertip touching the top panel 120, a tactile sensation (stroke feeling) of pressing a mechanical button realized by a key dome, for example.

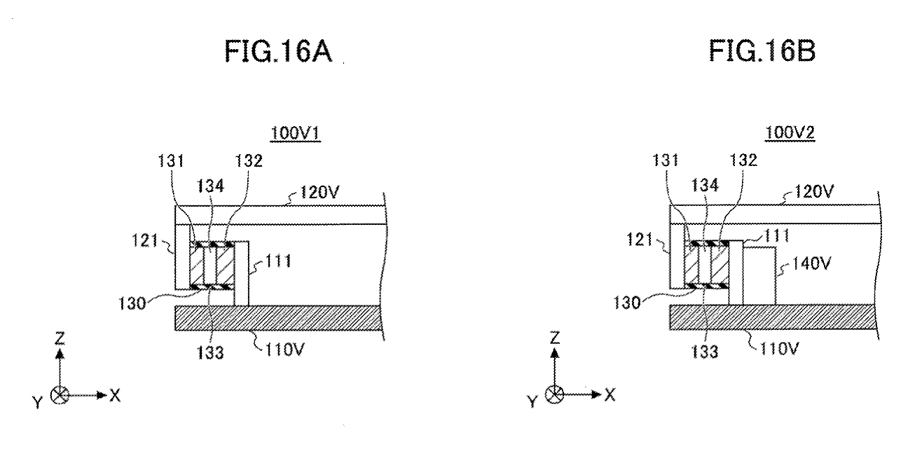

In the above described embodiment, the supports 130 are disposed, between the housing 110 and the top panel 120, along the Z axis direction. However, the supports 130 may be disposed as illustrated in FIGS. 16A and 16B.

FIG. 16A is a diagram illustrating a part of an electronic device 100V1 according to a variation example of the first embodiment. FIG. 16B is a diagram illustrating a part of an electronic device 100V2 according to a variation example of the first embodiment. The electronic device 100V1, illustrated in FIG. 16A, includes a housing 110V, a top panel 120V, and a support 130. Although the electronic device 100V1 includes a vibrating element 140, a touch panel 150, a display panel 160, and a substrate 170 similar to those of the electronic device 100 illustrated in FIG. 2 and FIG. 3, their illustrations are omitted in FIG. 16A.

The housing 110V is a plate shaped housing, and includes a wail part 111 on a positive side surface in the Z axis direction. The top panel 120V includes a wall part 121 on a negative side surface in the Z axis direction. Both of the wall parts 111 and 121 extend in the Y axis direction.

The support 130 is disposed between the wall parts 111 and 121 as illustrated in FIG. 16A. The support 130 disposed as illustrated is more easily displaced in the Z axis direction and the Y axis direction than being displaced in the X axis direction.

Therefore, according to the arrangement of the housing 110V, the top panel 120V, and the support 130 as illustrated in FIG. 16A, it is possible to provide the electronic device 100V1 that can more easily provide a stroke feeling in the Z axis direction.

Further, a vibrating element 140V may be arranged as illustrated in FIG. 16B. In an electronic device 100V2 illustrated in FIG. 16B, the vibrating element 140V is added to the electronic device 100V1 illustrated in FIG. 16A. The vibrating element 140V is bonded on a positive side surface of the wall part 111 of the housing 110V in the X axis direction.

Such a vibrating element 140V is provided in order to generate a vibration in the audible range in the top panel 120. The vibrating element 140V is an example of a second vibrating element.

The vibrating element 140V may be any element that can generate a vibration in the audible range, and for example, a Linear Resonant Actuator (LRA), an eccentric motor (Eccentric Rotating Mass: ERM), or the like may be used. The LRA is an element that includes a coil and a magnet and vibrates the coil up and down by causing a magnetic field, generated by an electric current flowing through the coil, and a magnetic field of the magnet to repel. The eccentric motor is an element that generates vibration by rotating a rotator of which weight is biased with respect to a rotational axis.

The vibrating element 140V is driven through the second driving signal output from the drive controlling part 240. An amplitude (intensity) and a frequency of the vibration that is generated by the vibrating element 140V is set by the driving signal.

Although the vibrating element 140V is bonded on the positive side surface of the wall part 111 of the housing 110V in the X axis direction in the described embodiment here, the vibrating element 140V may be disposed at another location of the housing 110V. For example, the vibrating element 140V may be attached to the support 130, or may be disposed on the top panel 120.

A piezoelectric element may be used as the vibrating element 140V. In this case, the natural vibration in the ultrasound frequency band may be generated in the top panel 120 by driving the vibrating element 140V through the first driving signal.

### Second Embodiment

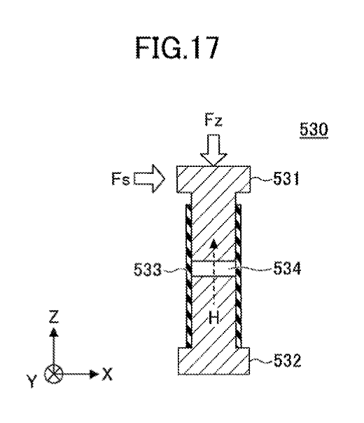

FIG. 17 is a cross sectional view illustrating a structure of a support 530 according to a second embodiment. The cross sectional structure illustrated in FIG. 17 corresponds to that of FIG. 6. An electronic device according to the second embodiment includes the supports 530 instead of the supports 130 according to the first embodiment. Note that because other configuration elements of the electronic device of the second embodiment are similar to those of the first embodiment, only the supports 530 will be described here.

The support 530 includes a base part 531, a base part 532, a housing 533, and a Magneto-Rheological (MR) fluid 534. Note that FIG. 17 illustrates an XYZ coordinate system the same as if FIG. 6. A magnetic field is used to control the support stiffness of the supports 530.

The base part 531 and the base part 532 seal the top and bottom of the cylindrical housing 533, respectively. The MR fluid 534 is enclosed in an internal space formed by the base part 531, the base part 532, and the housing 533.

The MR fluid 534 is a fluid of which the viscosity is changed by an applied magnetic field H. When a magnetic field H is not applied, the viscosity of the MR fluid 534 is low. On the other hand, when a magnetic field H is applied, the viscosity of the MR fluid 534 increases.

The MR fluid 534 is slurry obtained by dispersing, in a solvent such as poly-α-olefin, a ferromagnetic powder in high concentration. Thus, when the magnetic field H is applied, in the Z axis direction, between the base part 531 and the base part 532, the support stiffness in the Z axis direction is increased because the ferromagnetic powder is aligned in the Z axis direction.

In the support 530, which encloses such a MR fluid 534, the support stiffness between the base parts 531 and 532 of the support 530 can be changed by controlling the magnetic field H in the Z axis direction. The support, stiffness is increased by strengthening the magnetic field H, and the support stiffness is decreased by weakening the magnetic field H.

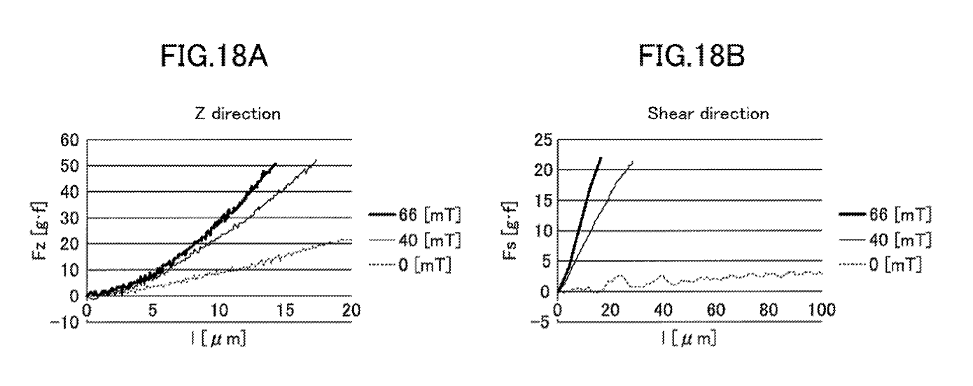

FIGS. 18A and 18B are diagrams illustrating results of measuring amounts of (amount of push) of the support 530 being compressed in the Z axis direction with respect to an external force Fz, applied to the support 530 in the Z axis direction, and with respect to an external force Fs applied in a shearing direction. In FIG. 18A, a horizontal axis represents an amount l (μm) of push of the base parts 531 and 532, and a vertical axis represents an external force Fz (g·f). In FIG. 18B, a horizontal axis represents an amount l (μm) of push of the base parts 531 and 532, and a vertical axis represents an external force Fs (g·f).

As illustrated in FIG. 17, the external force Fz is an external force applied in the Z axis direction to compress the support 530. A reaction force to the external force Fz corresponds to a magnitude of the support stiffness between the base part 531 and the base part 532 of the support 530 in the Z axis direction.

As illustrated in FIG. 17, the external force Fs is an external force applied in a direction (shearing direction) so that the base part 531 and the 532 are displaced in the X axis direction and the Y axis direction.

Here, instead of the magnetic field H, a magnitude of the magnetic field H is represented by a magnetic flux density between the base part 531 and the base part 532 in the Z axis direction. FIG. 18B differs from FIG. 18A in scales of the horizontal axis and the vertical axis.

As illustrated in FIG. 18A, the external force Fz increases as the amount l of push increases. The increasing amount, of the external force Fz is minimum in a case where the magnetic flux density is 0 (mT), is second largest in a case where the magnetic flux density is 40 (mT), and is the largest in a case where the magnetic flux density is 60 (mT).

In the case where the magnetic flux density is 0 (mT), the external force Fz is about 22 (g·f) when the amount l of push is about 20 (μm). In the case where the magnetic flux density is 60 (mT), the external force Fz is about 50 (g·f) when the amount l of push is about 13 (82 m).

As illustrated in FIG. 18B, in a case where the magnetic flux density is 0 (mT), the external force Fs does not largely increase even when the amount l of push increases. However, in a case where the magnetic flux density is 40 (mT) and a case where the magnetic flux density is 60 (mT), the external force Fs increases as the amount l of push increases. The increasing amount of the external force Fs is larger in the case where the magnetic flux density is 60 (mT) than in the case where the magnetic flux density is 40 (mT).

In the case where the magnetic flux density is 0 (mT), the external force Fs is about 3 (g·f) when the amount l of push is about 100 (μm). In the case where the magnetic flux density is 60 (mT), the external force Fs is about 22 (g·f) when the amount l of push is about 15 (μm).

As described above, in a case where the magnetic field in the Z axis direction applied to the MR fluid 534 is small, in addition to the displacement in the Z axis direction of narrowing the interval between the base parts 531 and 532, the support 530 can be displaced so that the base parts 531 and 532 are displaced in the X axis direction and the Y axis direction in comparison with a case where the magnetic field in the Z axis direction applied to the MR fluid 534 is large.

When generating the natural vibration in the ultrasound frequency band in the top panel 120, the electronic device according to the second embodiment sets the support stiffness of the supports 530 to be high. At this time, the support stiffness is the first level. When generating the vibration in the audible range in the top panel 120, the electronic device according to the second embodiment sets the support stiffness of the supports 530 to be low. At this time, the support stiffness is the second level.

The support stiffness of the first level may be a high value such that the natural vibration in the ultrasound frequency band can be generated in the top panel 120 by driving the vibrating element 140, and may be a value about 2.0×10⁹ (Pa), for example.

The support stiffness of the second level may be a low value such that the vibration in the audible range can be generated in the top panel 120 by driving the vibrating element 140, and may be a value about 2.6×10⁶ (Pa), for example.

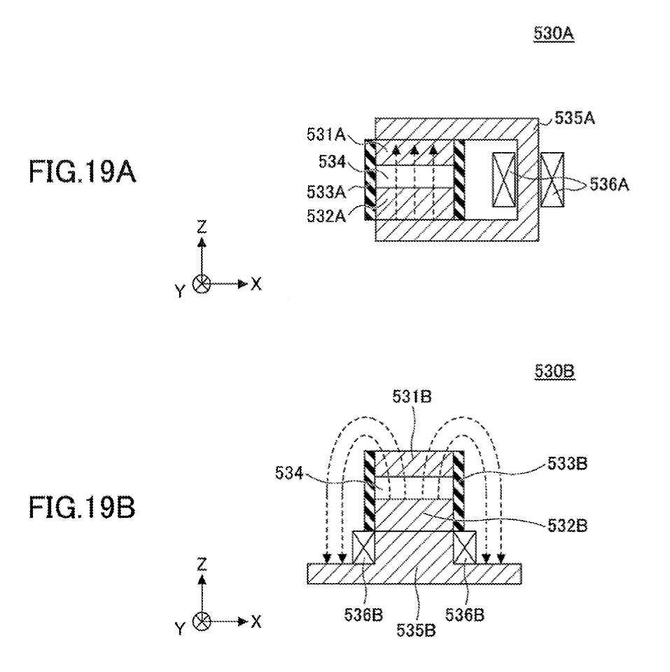

FIG. 19A is a cross sectional view illustrating a support 530A. FIG. 19B is a cross sectional view illustrating a support 530B. The supports 530A and 530B have a configuration of applying a magnetic field B.

The support 530A illustrated in FIG. 19A includes a base part 531A, a base part 532A, a housing 533A, the MR fluid 534, a yoke 535A, and a coil 536A.

The base part 531A, the base part 532A, the housing 533A respectively correspond to the base part 531, the base part 532, and the housing 533 illustrated in FIG. 17. The base part 531A and the base part 532A are housed inside of the housing 533A.

Because the base part 531A, the base part 532A, and the yoke 535A constitute a part of the magnetic path, they may be formed of magnetic materials such as ferrite or iron oxide. The housing 533A may be a non-magnetic material and may be an insulator material such as silicone rubber. Together with the base parts 531A and 532A, the housing 533A seals the MR fluid 534.

The yoke 535A is formed into a U shape so as to couple the positive side surface of the base part 531A in the Z axis direction and the negative side surface of the base part 532A in the Z axis direction. The yoke 535A, the base part 531A, the base part 532A, and the MR fluid 534 constitute a magnetic circuit having a rectangular shape in plan view.

The yoke 535A is configured to bend when the base parts 531A and 532A are displaced in the Z axis direction. Thus, the support 530A can be displaced to be compressed. Note that the base parts 531A and 532A and the yoke may be integrally formed.

The coil 536A is wound around the yoke 535A, at a positive side part of the yoke 535A in the X axis direction. By causing an electric current to flow through the coil 536A in a clockwise direction as viewed from a positive side in the Z axis direction to a negative side in the Z axis direction, a magnetic field H in the positive side Z axis direction, as indicated by the arrows, can be applied to the MR fluid 534.

In the support 530A having such a configuration, when an electric current is caused to flow through the coil 536A, a magnetic path, such as magnetic flux generated by the coil 536A penetrating inside the MR fluid 534 through the yoke 535A and the base part 532A, as indicated by the arrows and thereafter returning to the yoke 535A through the base part 531A, is formed.

When an amount of electric current that flows through the coil 536A is adjusted by the drive controlling part 240, the viscosity of the MR fluid 534 is changed. Therefore, the support stiffness of the support 530A can be controlled. As the amount of electric current that flows through the coil 536A increases, the viscosity of the MR fluid 534 increases and the support stiffness increases.

The supports 530A having the configuration as described may be used instead of the supports 130 illustrated in FIG. 2 and FIG. 3B.

The support 530B illustrated in FIG. 19B includes a base part 531B, a base part 532B, a housing 533B, the MR fluid 534, a yoke 535B, and a coil 536B.

The base part 531B, the base part 532B, the housing 533B respectively correspond to the base part 531, the base part 532, and the housing 533 illustrated in FIG. 17. The base part 531B and the base part 532B are housed inside of the housing 533B.

Because the base part 531B, the base part 532B, and the yoke 535B constitute a part of the magnetic path, they may be formed of magnetic materials such as ferrite or iron oxide. The housing 533B may be a non-magnetic material and may be an insulator material such as silicone rubber. Together with the base parts 531B and 532B, the housing 533B seals the MR fluid 534.

The yoke 536B is coupled to the negative side surface of the base part 532B in the Z axis direction. The yoke 535B is disposed on the negative side of the base part 532B in the Z axis direction.

The coil 536B is wound around the yoke 535B so as to be adjacent to a negative side of the base part 532B in the Z axis direction. By causing an electric current to flow through the coil 536B in a counter clockwise direction as viewed from a positive side in the Z axis direction to a negative side in the Z axis direction, a magnetic path, of magnetic flux passing in the negative side Z axis direction surrounding the housing 533B from a positive side of the base part 531B in the Z axis direction and returning to the yoke 535B, is constituted.

In this way, the magnetic field H in the Z axis direction indicated, by the arrows can be applied to the MR fluid 534.

When an amount of electric current that flows through the coil 536B is adjusted by the drive controlling part 240, the viscosity of the MR fluid 534 is changed. Therefore, the support stiffness of the support 530B can be controlled. As the amount of electric current that flows through the coil 536B increases, the viscosity of the MR fluid 534 increases and the support stiffness increases.

The supports 530B having the configuration as described may be used instead of the supports 130 illustrated in FIG. 2 and FIG. 3B.

As described above, according to the second embodiment, in a case of generating the natural vibration in the ultrasound frequency band in the top panel 120, the vibrating element 140 is driven through the first driving signal for generating the natural vibration in the ultrasound frequency band after setting the level of the support stiffness of the supports 530A or 530B to be the first level (high level).

Hence, the natural vibration in the ultrasound frequency band of which the amplitude is large can be efficiently generated in the top panel 120, and the user can more easily feel the change of the kinetic friction force applied to his or her fingertip. Thus, it is possible to provide favorable tactile sensations to the user.

Further, according to the second embodiment, in a case of generating the vibration in the audible range in the top panel 120, the vibrating element 140 is driven through the second driving signal for generating the vibration in the audible range after setting the level of the support stiffness of the supports 530A or 530B to be the second level (low level).

Hence, the vibration in the audible range of which the amplitude is large can be efficiently generated in the top panel 120, and the user can more easily feel the vibration through his or her fingertip. Thus, it is possible to provide favorable tactile sensations to the user.

As described above, according to the second embodiment, it is possible to increase both the amplitude of the natural vibration in the ultrasound frequency band and the amplitude of the vibration in the audible range by switching the level of the support stiffness of the supports 530A or 530B. Thus, it is possible to provide the electronic device that can provide various favorable tactile sensations.

Although examples of an electronic device according to the embodiments of the present invention have been described, the present invention is not limited to the embodiments specifically disclosed and various variations and modifications may be made without departing from the scope of the present invention.

According to an embodiment, a method for controlling an electronic device including a top panel having a manipulation input surface on a surface side of the top panel; a coordinate detector configured to detect coordinates of a manipulation input performed on the manipulation input surface; a housing disposed on a back surface side of the top panel; a first vibrating element disposed on the top panel; at least one support configured to support the top panel with respect to the housing, support stiffness of the at least one support with respect to the housing being switchable between a first level and a second level that is less than the first level; and a second vibrating element disposed on the back surface of the top panel, the at least one support, or the housing, includes setting the support, stiffness of the at least one support to the first level when driving the first vibrating element, by using a first driving signal for generating a natural vibration in an ultrasound frequency band in the manipulation input surface; and setting the support stiffness of the at least one support to the second level when driving the second vibrating element, by using a second driving signal for generating a vibration in an audible range in the manipulation input surface.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the spirit and scope of the invention.

What is claimed is:

1. An electronic device comprising:
a top panel having a manipulation input-surface on a surface side of the top panel;
a coordinate detector configured to detect coordinates of a manipulation input performed on the manipulation input surface;
a housing disposed on a back surface side of the top panel;
a first vibrating element, disposed on the top panel;
at least one support configured to support the top panel with respect to the housing, support stiffness of the at least one support with respect to the housing being switchable between a first level and a second level that is less than the first level; and
a controlling part configured to set the support stiffness of the at least one support to the first level when driving the first vibrating element, by using a first driving signal for generating a natural vibration in an ultrasound frequency band in the manipulation input surface; and to set the support stiffness of the at least one support to the second level when driving the first vibrating element, by using a second driving signal for generating a vibration in an audible range in the manipulation input surface.

2. An electronic device comprising:
a top panel having a manipulation input surface on a surface side of the top panel;
a coordinate detector configured to detect coordinates of a manipulation input performed on the manipulation input surface;
a housing disposed on a back surface side of the top panel;
a first vibrating element disposed on the top panel;
at least one support configured to support the top panel with respect, to the housing, support stiffness of the at least one support with respect to the housing being switchable between a first level and a second level that is less than the first level; and
a second vibrating element disposed on the back surface of the top panel, the at least one support, or the housing; and
a controlling part configured to set the support stiffness of the at least one support to the first level when driving the first vibrating element, by using a first driving signal for generating a natural vibration in an ultrasound frequency band in the manipulation input surface; and to set the support stiffness of the at least one support to the second level when driving the second vibrating element, by using a second driving signal for generating a vibration in an audible range in the manipulation input surface.

3. The electronic device according to claim 1,
wherein the at least one support includes a fluid, of which viscosity is changed by electric or magnetic action based on a control, signal, input from the controlling part, and
wherein the support stiffness of the at least one support is set to be the first level or the second level by the control signal.

4. The electronic device according to claim 1,
wherein the at least one support includes
a first support part fixed to the top panel,
a second support part fixed to the housing,
a fluid disposed between the first support part and the second support part, viscosity of the fluid being changed by a change in an electric field or a magnetic field, and
an applying part configured to apply the electric field or the magnetic field to the fluid,
wherein the electric field or the magnetic field that the applying part applies to the fluid is controlled, through a control signal input from the controlling part, to change the viscosity of the fluid so that the support stiffness of the at least one support is set to be the first level or the second level.

5. The electronic device according to claim 1, wherein the first driving signal is a driving signal for driving the first driving element so that an intensity of the natural vibration is changed in response to an amount of movement of a position of the manipulation input on the manipulation input surface.

6. The electronic device according to claim 1, wherein the controlling part selects, in accordance with the manipulation input on the manipulation input surface, a first driving mode or a second driving mode, the first driving mode setting the support stiffness of the at least one support to the first level and driving the first vibrating element through the first driving signal, the second driving mode setting the support stiffness of the at least one support, to the second level and driving the first vibrating element through the second driving signal.

7. The electronic device according to claim 6, wherein the support stiffness of the at least one support is changed so as to provide a tactile sensation corresponding to the manipulation input on the manipulation input surface even when the first driving mode and the second driving mode are not selected.

8. The electronic device according to claim 1, wherein the first driving signal is a driving signal for generating the natural vibration in the ultrasound frequency band in the manipulation input surface; at a fixed frequency and a fixed phase.

9. The electronic device according to claim 1,
wherein the manipulation input surface has a rectangular shape having long sides and short sides in plan view, and
wherein the controlling part vibrates the first vibrating element to generate a standing wave of which amplitude varies in a direction of the long sides of the manipulation input surface.

10. The electronic device according to claim 1, further comprising:
a display part disposed between the top panel and the housing.

11. A method for controlling an electronic device, the electronic device including a top panel having a manipulation Input surface on a surface side of the top panel; a coordinate detector configured to detect coordinates of a manipulation input performed on the manipulation input surface; a housing disposed on a back surface side of the top panel; a first vibrating element disposed on the top panel; and at least one support configured to support the top panel with respect to the housing, support stiffness of the at least one support with respect to the housing being switchable between a first level and a second level that is less than the first level, the method comprising:
setting the support stiffness of the at least one support to the first level, when driving the first vibrating element, by using a first driving signal for generating a natural vibration in an ultrasound frequency band in the manipulation input surface; and setting the support stiffness of the at least one support to the second level when driving the first vibrating element, by using a second driving signal for generating a vibration in an audible range in the manipulation input surface.

12. The method according to claim 11,
wherein the at least one support includes a fluid, of which viscosity is changed by electric or magnetic action, and
wherein the support stiffness of the at least one support is set to be the first level or the second level by the control signal.

13. The method according to claim 11,
wherein the at least one support includes
a first support part fixed to the top panel,
a second support part fixed to the housing,
a fluid disposed between the first support part and the second support part, viscosity of the fluid being changed by a change in an electric field or a magnetic field, and
an applying part configured to apply the electric field or the magnetic field to the fluid,
wherein the electric field or the magnetic field that the applying part applies to the fluid is controlled to change the viscosity of the fluid so that the support stiffness of the at least one support is set to be the first level or the second level.

14. The method according to claim 11, wherein the first driving signal is a driving signal for driving the first driving element so that an intensity of the natural vibration is changed in response to an amount of movement of a position of the manipulation input on the manipulation input surface.

15. The method according to claim 11, wherein a first driving mode or a second driving mode is selected m accordance with the manipulation input on the manipulation input surface, the first driving mode setting the support stiffness of the at least one support to the first level and driving the first vibrating element through the first driving signal, the second driving mode setting the support stiffness of the at least one support to the second level and driving the first vibrating element through the second driving signal.

16. The method according to claim 11, wherein the support stiffness of the at least one support is changed so as to provide a tactile sensation corresponding to the manipulation input on the manipulation input surface even when the first driving mode and the second driving mode are not selected.
